(19) United States
(12) Patent Application Publication
(10) Pub. No.: US 2025/0355161 A1
(43) Pub. Date: Nov. 20, 2025

(54) POLARIZATION-MAINTAINING OPTICAL FIBER

(71) Applicant: CORNING INCORPORATED, Corning, NY (US)

(72) Inventors: Kevin Wallace Bennett, Hammondsport, NY (US); Scott Robertson Bickham, Corning, NY (US); Garth Weber Scannell, Corning, NY (US); Zhiye Zhang, Hickory, NC (US)

(21) Appl. No.: 19/205,247

(22) Filed: May 12, 2025

Related U.S. Application Data
(60) Provisional application No. 63/648,930, filed on May 17, 2024.

(51) Int. Cl. G02B 6/024; G02B 6/036

(52) U.S. Cl. CPC G02B 6/024; G02B 6/03694

(57) ABSTRACT

A polarization-maintaining fiber may include a core region having a radius R1, a trench region having an inner radius R2 and an outer radius R3, and a fiber radius R4, and two stress regions symmetrically located in an annular region having an inside radius R5 and an outside radius R6. The inner radius R2 of the trench region may be less than or equal to the inside radius R5 of the annular region.

This application claims the benefit of priority under 35 U.S.C. § 119 of U.S. Application Ser. No. 63/648,930 filed on May 17, 2024, the content of which is relied upon and incorporated herein by reference in its entirety.

### FIELD

The disclosure relates to optical fiber, and more particularly to polarization-maintaining optical fibers.

### BACKGROUND

In existing polarization-maintaining fibers that employ low-index stress rods, the low-index stress rods can in some instances result in non-uniform bend response, such as very low bend sensitivity along the slow axis and much higher bend losses along the fast axis, producing a large mismatch between the bend performances along the fast axis and the slow axis of the polarization-maintaining fiber. Thus, there is a need for polarization-maintaining fibers that enable a more uniform bend response between the fast and slow axes.

Additionally, many polarization-maintaining fiber applications utilize lengths on the order of 0.5 m, which places stringent requirements on the cutoff wavelength to enable single-mode operation. Thus, there is also a need for polarization-maintaining fibers to enable single-mode operation in short-distance (e.g., 0.5 m or less) applications in various target operating windows (e.g., O-band (1270-1330 nm) and/or C-band (1530-1565 nm)).

### SUMMARY

Described herein are polarization-maintaining fibers, including bend-insensitive polarization-maintaining fibers.

In some embodiments, a polarization-maintaining fiber may include a core region having a radius R1, a trench region having an inner radius R2 and an outer radius R3, and a fiber radius R4. The polarization-maintaining fiber may further include stress regions, such as boron-doped stress regions, that may be symmetrically located in an annular region having an inside radius R5 and an outside radius R6. In some embodiments, the inner radius R2 of the trench region may be less than or equal to the inside radius R5 of the annular region such that the stress regions may be disposed further away from the core region. In some embodiments, a ratio of the radius R1 of the core region to the inner radius R2 of the depressed index trench region may be greater than or equal to 0.4. In some embodiments, a core volume V1 of the core region may be about 4.0%-sq. microns to about 6.0%-sq. microns, and a trench volume V3 of the depressed index trench region may be about −80%-sq. microns to about −20%-sq. microns.

In some embodiments, a polarization-maintaining fiber may include a core region having a radius R1, a cladding region having an outer radius R4 and comprising a depressed index trench region having an inner radius R2 and an outer radius R3, and a stress region located in an annular region having an inside radius R5 and an outside radius R6. In some embodiments, a center of the stress region may be offset from a centerline of the core region, and the inner radius R2 of the trench region may be less than or equal to the inside radius R5 of the annular region.

In some embodiments, a polarization-maintaining fiber may include a core region having a radius R1, a cladding region surrounding the core region and having an outer radius R4, and a first stress region located in a first annular region having an inside radius R5 and an outside radius R6, and a second stress region located in a second annular region having an inside radius R7 and an outside radius R8. In some embodiments, the first stress region may be configured to create compressive stress on the core region, and the second stress region may be configured to create tensile stress on the core region.

In some embodiments, a polarization-maintaining fiber may include a core region having a radius R1, a cladding region surrounding the core region and having an outer radius R4, and a stress region located in an annular region having an inside radius R7 and an outside radius R8. In some embodiments, a center of the stress region may be offset from a center line of the core region, and the stress region may include a titania-doped stress region. In some embodiments, the inner radius R7 of the annular region may be greater than or equal to the radius R1 of the core region, and the outer radius R8 of the annular region may be less than or equal to the radius R4 of the cladding region.

The polarization-maintaining fiber, such as the bend-insensitive polarization-maintaining fiber, described herein may enable a uniformly low bend loss between the fast and slow axes when the polarization-maintaining fiber may be bend along either the fast axis or the slow axis. Further, in some embodiments, the polarization-maintaining fiber described herein, including the bend-insensitive polarization-maintaining fiber described herein, may enable operation in single mode in short-length (e.g., 0.5 m or less) applications in target operating windows of both C-band (1530-1565 nm) and/or O-band (1270-1330 nm).

Additional features and advantages will be set forth in the detailed description which follows, and in part will be readily apparent to those skilled in the art from the description or recognized by practicing the embodiments as described in the written description and claims hereof, as well as the appended drawings.

### BRIEF DESCRIPTION OF THE DRAWINGS

The accompanying drawings are included to provide a further understanding and are incorporated in and constitute a part of this specification. The drawings illustrate one or more embodiment(s), and together with the detailed description serve to explain principles and operation of the various embodiments. As such, the disclosure will become more fully understood from the following detailed description, taken in conjunction with the accompanying figures.

FIG. 1 schematically illustrates an exemplary polarization-maintaining fiber.

FIG. 2 plots a schematic (not to scale) exemplary relative refractive index profile of a polarization-maintaining fiber taken along the fast axis of the polarization-maintaining fiber.

FIGS. 3A and 3B plot schematic (not to scale) exemplary relative refractive index profiles of polarization-maintaining fibers taken along the slow axes of the polarization-maintaining fibers.

FIG. 4 schematically illustrates another exemplary polarization-maintaining fiber.

FIG. 5A schematically illustrates bending an exemplary polarization-maintaining fiber along the fast axis of the polarization-maintaining fiber.

FIG. 5B schematically illustrating bending an exemplary polarization-maintaining fiber along the slow axis of the polarization-maintaining fiber.

FIG. 6 shows a measured exemplary relative refractive index profile of an optical fiber that exhibits short-length cutoff wavelength below C-band.

FIG. 7 is a plot of the cutoff wavelength as a function of length for the fiber of FIG. 6.

FIG. 8 shows measured exemplary relative refractive index profiles of optical fibers that exhibit short-length cutoff wavelengths below O-band.

FIG. 9 is a plot of the cutoff wavelength as a function of length for the fibers of FIG. 8.

FIG. 10 schematically illustrates another exemplary polarization-maintaining fiber.

FIG. 11 plots a schematic (not to scale) exemplary relative refractive index profile of a polarization-maintaining fiber taken along the fast axis of the polarization-maintaining fiber.

FIG. 12 schematically illustrates another exemplary polarization-maintaining fiber.

FIG. 13 schematically illustrates another exemplary polarization-maintaining fiber.

FIG. 14 schematically illustrates another exemplary polarization-maintaining fiber.

FIG. 15 schematically illustrates another exemplary polarization-maintaining fiber.

FIG. 16 schematically illustrates another exemplary polarization-maintaining fiber.

FIG. 17 schematically illustrates another exemplary polarization-maintaining fiber.

FIG. 18 schematically illustrates another exemplary polarization-maintaining fiber.

FIG. 19 schematically illustrates another exemplary polarization-maintaining fiber.

FIG. 20A shows simulated birefringence characteristics of a portion of a core region of an exemplary polarization-maintaining fiber.

FIG. 20B shows simulated birefringence characteristics of a portion of a core region of another exemplary polarization-maintaining fiber.

FIG. 20C shows simulated birefringence characteristics of a portion of a core region of another exemplary polarization-maintaining fiber.

FIG. 21 is a plot of modeled birefringence of exemplary polarization-maintaining fibers.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this detailed description.

In this document, relational terms, such as first and second, top and bottom, and the like, are used to distinguish one entity or action from another entity or action, without necessarily requiring or implying any actual such relationship or order between such entities or actions.

It will be understood by one having ordinary skill in the art that construction of the described apparatus and/or components is not limited to any specific material. Exemplary embodiments disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

In this specification and in the claims which follow, reference will be made to a number of terms which shall be defined to have the following meanings:

“Optical fiber” refers to a waveguide having a glass portion surrounded by a coating. The glass portion includes a core and a cladding and is referred to herein as a “glass fiber.”

“Radial position”, “radius”, or the radial coordinate “r” or “R” refers to radial position relative to the centerline (r=0) of the fiber.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g., core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g., core region and/or any of the cladding regions) is expressed as a single value or as a parameter (e.g. A or 4%) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by equation (1) below, unless otherwise specified. Whether by design or a consequence of normal manufacturing variability, the dependence of relative refractive index on radial position may be sloped, curved, or otherwise non-constant.

“Relative refractive index,” as used herein, is defined in equation (1) as:

$${Δ}_{i} ( {r}_{i} ) \% = 100 \frac{( {n}_{i}^{2} - {n}_{ref}^{2} )}{2 {n}_{i}^{2}} \qquad ( 1 )$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ % (or “delta %) and its values are given in units of “%”, unless otherwise specified. Relative refractive index may also be expressed as Δ(r) or Δ(r) %.

The average relative refractive index (Δₐᵥₑ) of a region of the fiber is determined from equation (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, router is the outer radius of the region, and A (r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by equation (1).

The term “a-profile” or “alpha profile” refers to a relative refractive index profile Δ(r) that has the functional form defined in equation (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, Δ(rₒ)>0, r_{z}>rₒ is the radial position at which Δ(r) decreases to its minimum value, and r is in the range rᵢ≤r<r_{f}, where rᵢ is the initial radial position of the α-profile, rᵣ is the final radial position of the α-profile, and a is a real number. Δ(rₒ) for an α-profile may be referred to herein as Aₘₐₓ or, when referring to a specific region i of the fiber, as Δᵢₘₐₓ. When the relative refractive index profile of the fiber core region is described by an α-profile with rₒ occurring at the centerline (r=0), r_{z} corresponding to the outer radius rᵢ of the core region, and Δ₁(r₁)=0, equation (3) simplifies to equation (4):

$${Δ}_{1} ( r ) = {Δ}_{1 max} [ 1 - {[ \frac{r}{{r}_{1}} ]}^{α} ] \qquad ( 4 )$$

When the core region has an index described by equation (4), the outer radius r₁ can be determined from the measured relative refractive index profile by the following procedure. Estimated values of the maximum relative refractive index Δ₁ₘₐₓ, «, and outer radius rₗₑₛₜ are obtained from inspection of the measured relative refractive index profile and used to create a trial function Δₜᵣᵢₐₗ between r=0 and r=rₗₑₛₜ. The sum of the squares of the difference between the trial function and the measured profile (Δₘₑₐₛ), λ²=Σ(Δₜᵣᵢₐₗ-Δₘₑₐₛ)², is minimized over values of r ranging between 0.1 rₗₑₛₜ and 0.95 rₗₑₛₜ using the Nelder-Mead algorithm (Nelder, John A. and R. Mead, “A simplex method for function minimization,” Computer Journal 7:308-313(1965)) to determine Δ₁ₘₐₓ, «, and r₁.

The “core volume” V1 is defined as:

$${V}_{1} = 2 {\int }_{0}^{{r}_{1}} {Δ}_{1} ( r ) rdr \qquad ( 5 )$$

where r₁ is the outer radius of the refractive index profile of the core region, Δ₁(r) is the relative refractive index of the core region of the refractive index profile, and r is radial position in the fiber. The core volume V₁ is a positive quantity and will be expressed herein in units of % Δ-μm², which may also be expressed as % Δμm² or % Δ-micron², or % Δ-sq. microns.

“Trench volume” is defined as:

$${V}_{Trench} = 2 {\int }_{{r}_{Trench , inner}}^{{r}_{Trench , outer}} {Δ}_{Trench} ( r ) rdr \qquad ( 6 )$$

where “Trench, inner is the inner radius of the trench region of the refractive index profile, “Trench, outer is the outer radius of the trench region of the refractive index profile, Δ_{Trench}(r) is the relative refractive index of the trench region of the refractive index profile, and r is radial position in the fiber. Trench volume will be expressed herein in units of % Δmicron², % Δ-micron², % Δ-μm², or % Δμm², whereby these units can be used interchangeably herein. A trench region is also referred to herein as a depressed-index cladding region and trench volume is also referred to herein as V3.

The “mode field diameter” or “MFD” of an optical fiber is defined in equation (7) as:

$$MFD = 2 w \qquad ( 7 )$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal and r is radial position in the fiber. “Mode field diameter” or “MFD” depends on the wavelength of the optical signal and is reported herein for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Effective area” of an optical fiber is defined in equation (8) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 8 )$$

where f(r) is the transverse component of the electric field of the guided optical signal and r is radial position in the fiber. “Effective area” or “A_{eff}” depends on the wavelength of the optical signal and is understood herein to refer to a wavelength of 1310 nm, 1550 nm, etc. Specific indication of the wavelength will be made when referring to effective area.

The term “attenuation,” as used herein, is the loss of optical power as the signal travels along the optical fiber. Attenuation was measured as specified by the IEC-60793-1-40 standard, “Attenuation measurement methods.”

The bend resistance of an optical fiber, expressed as “bend loss” herein, can be gauged by induced attenuation under prescribed test conditions as specified by the IEC-60793-1-47 standard, “Measurement methods and test procedures-Macrobending loss.” For example, the test condition can entail deploying or wrapping the fiber one or more turns around a mandrel of a prescribed diameter, e.g., by wrapping 1 turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

“Fiber cutoff” can be measured by the standard 2 m fiber cutoff test, FOTP-80 (EIA-TIA-455-80), to yield the “fiber cutoff wavelength”, also known as the “2 m fiber cutoff” or “measured cutoff”. The FOTP-80 standard test is performed to either strip out the higher order modes using a controlled amount of bending, or to normalize the spectral response of the fiber to that of a multimode fiber.

“Theoretical fiber cutoff wavelength,” or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

### Polarization-Maintaining Fiber

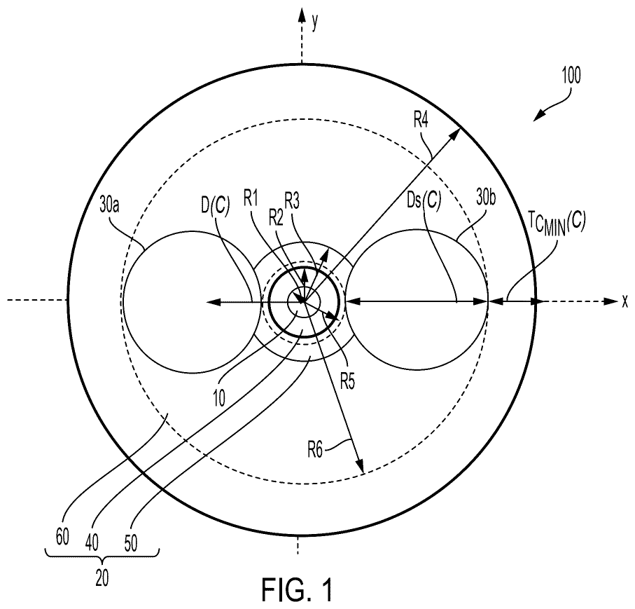

FIG. 1 schematically illustrates an exemplary polarization-maintaining fiber 100, more specifically, a bend-insensitive polarization-maintaining fiber 100. The bend-insensitive polarization-maintaining fiber 100 may include a core region 10, a cladding region 20 surrounding the core region 10, and two stress regions 30a, 30b located within the cladding region 20. The two stress regions 30a, 30b may each be configured to create compressive stress on the core region 10. The core region 10 may include a refractive index greater than the refractive index of the cladding region 20. The cladding region 20 may include an inner cladding region 40, a trench region 50, and an outer cladding region 60. The inner cladding region 40 may surround and directly contact the core region 10. The trench region 50 may surround and directly contact the inner cladding region 40. The outer cladding region 60 may surround and directly contact the trench region 50. In some embodiments, the bend-insensitive polarization-maintaining fiber 100 may further include a coating (not shown in FIG. 1), which may include a primary coating, a secondary coating, and/or a tertiary coating.

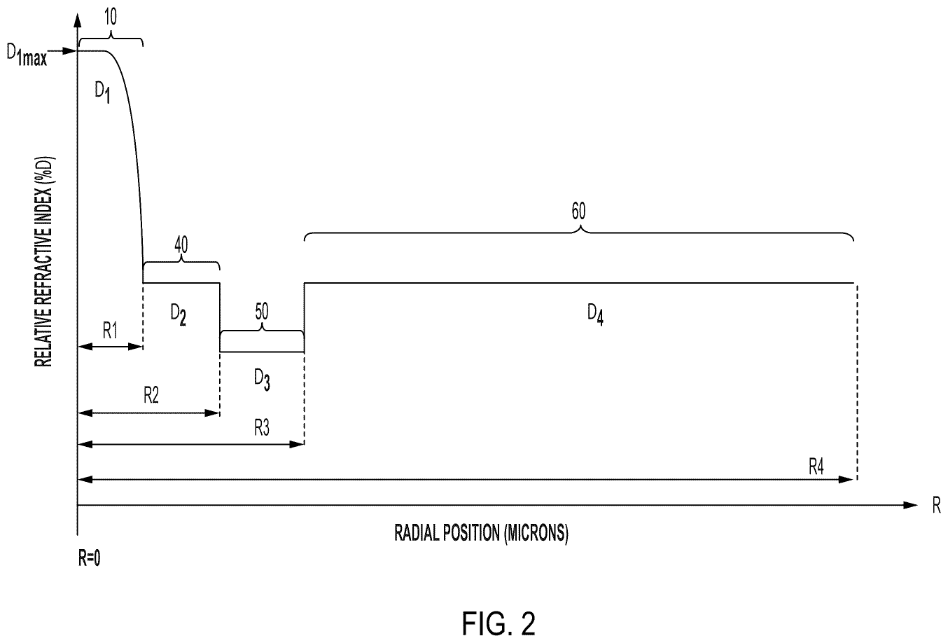

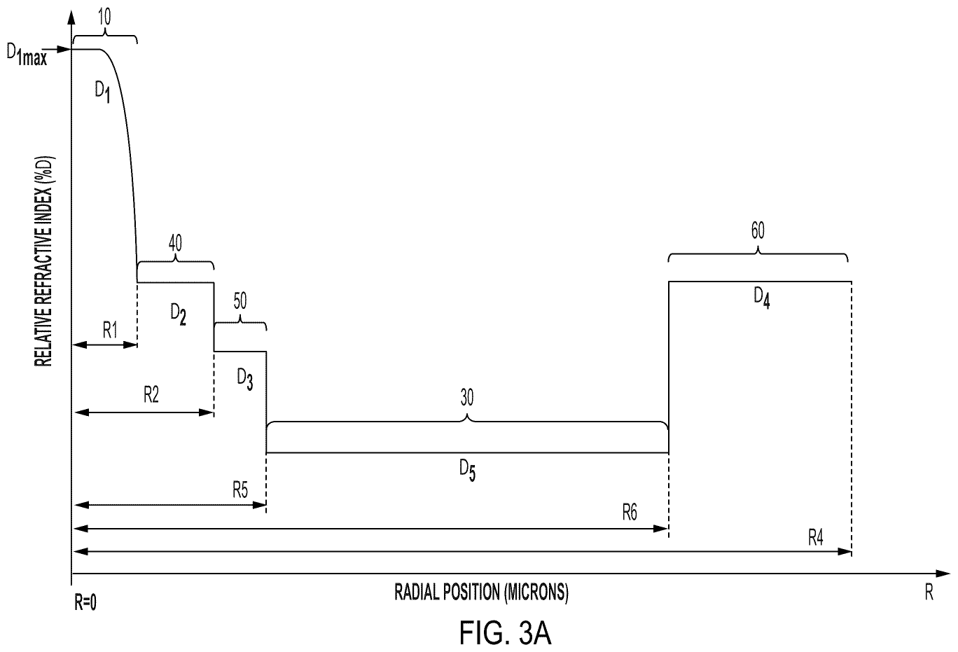

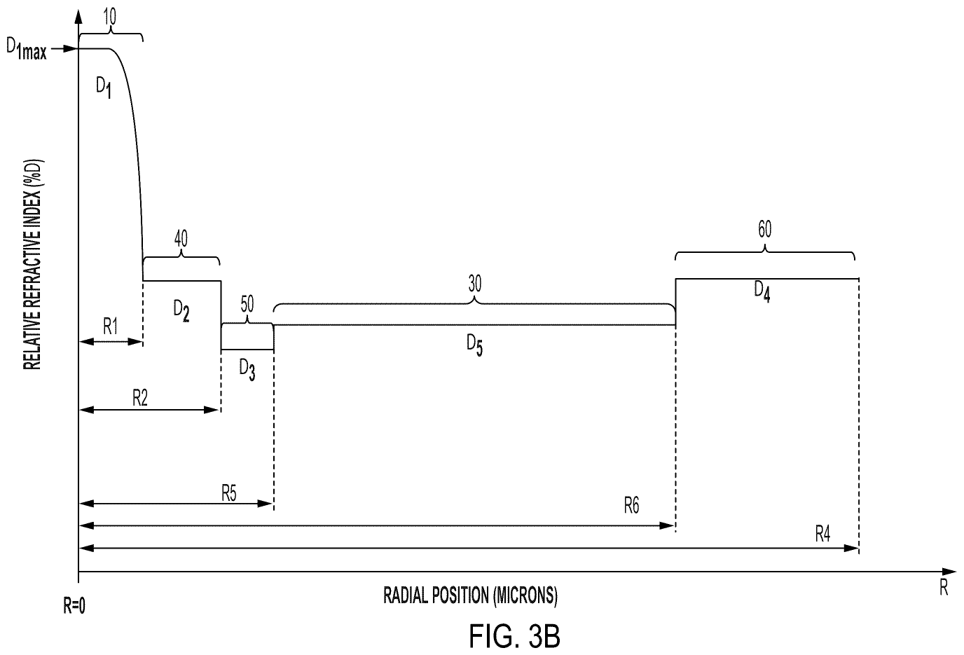

FIG. 2 plots a schematic (not to scale) exemplary relative refractive index profile of a bend-insensitive polarization-maintaining fiber taken along the fast axis (labeled as axis y of the bend-insensitive polarization-maintaining fiber 100 in FIG. 1) of the bend-insensitive polarization-maintaining fiber. FIGS. 3A and 3B plot schematic (not to scale) exemplary relative refractive index profiles of bend-insensitive polarization-maintaining fibers taken along the slow axes (or stress application axis, labeled as axis x of the bend-insensitive polarization-maintaining fiber 100 in FIG. 1) of the bend-insensitive polarization-maintaining fibers.

As used herein, the slow axis (axis x in FIG. 1) of the bend-insensitive polarization-maintaining fiber described herein extends through the centerline of the core region 10 and the centers of both stress regions 30a, 30b while the fast axis (axis y in FIG. 1) is perpendicular to the slow axis. A plane defined by the centerline of the core region 10 and the centers of both stress regions 30a, 30b contains the slow axis while the fast axis is perpendicular to the plane.

The core region 10 has relative refractive index Δ1, with a maximum refractive index of Δ0=Δ1_{MAX} at R=0 and a gradient α-profile, as described in more detail below. The inner cladding region 40 has a relative refractive index Δ2. The trench region 50 can be in the form of a depressed region and has a relative refractive index Δ3, with a minimum value Δ3_{MIN}. The outer cladding region 60 has a relative refractive index Δ4. In some embodiments, 44=Δ2. Furthermore, in some embodiments, Δ3_{MIN}<Δ2 and Δ3_{MIN}<Δ4. Other configurations for the relative refractive index profile are discussed further below. The stress regions 30a, 30b each have a relative refractive index Δ5, with a minimum value Δ5_{MIN}. In some embodiments, Δ5_{MIN}<Δ4. Further, in some embodiments, Δ5_{MIN}<Δ4 and Δ5_{MIN}≤Δ3_{MIN}, while in some embodiments, Δ5_{MIN}<Δ4 and Δ5_{MIN}≥Δ3_{MIN}, depending on the particular fiber design, such as dopant concentration implemented in the stress regions 30a, 30b as will be discussed further below.

### Core Region

The core region 10 may include silica glass that may be un-doped silica glass, up-doped silica glass, and/or down-doped silica glass. Up-doped silica glass may include silica glass doped with, for example, germanium (e.g., GeO₂), phosphorus (e.g., P₂O₅), aluminum (e.g., Al₂O₃), chlorine, or an alkali metal oxide (e.g., Na₂O, K₂O, Li₂O, Cs₂O, or Rb₂O). In some embodiments, the core region 10 may include germanium doped glass having a germanium concentration between about 4 wt. % and about 8 wt. %. In embodiments where the core may be doped with an alkali dopant, the peak concentration of the alkali in the silica glass may range from about 10 ppm to about 500 ppm, or from about 30 ppm to about 400 ppm. In yet other embodiments, the silica glass of the core region 10 may be free of germanium and/or chlorine. Down-doped silica glass may include silica glass doped with, for example, fluorine or boron.

The relative refractive index of the core region 10 is described by an α-profile with an α value that is in a range of about 20 or less, or about 18 or less, or about 16 or less, or about 15 or less, or about 14 or less, or about 12 or less, or about 10 or less, or about 8 or less, or about 6 or less, or about 5 or less, or about 4 or less, or about 3 or less, or about 2 or less. Additionally or alternatively, the a value may be about 5 or greater, or about 6 or greater, or about 7 or greater, or about 8 or greater, or about 9 or greater, or about 10 or greater, or about 11 or greater, or about 12 or greater. In some embodiments, the a value may be in a range from about 2 to about 20, or about 4 to about 18, or about 6 to about 14, or about 6 to about 10, or about 5 to about 12.

The core region 10 may include a radius R1 that may be greater than or equal to 3 μm and less than or equal to 7 μm-including all sub-ranges or values therebetween. For example, in some embodiments, the radius R1 of the core region 10 may be greater than or equal to 3 μm and less than or equal to 7 μm, greater than or equal to 3 μm and less than or equal to 6 μm, greater than or equal to 3 μm and less than or equal to 5 μm, greater than or equal to 4 μm and less than or equal to 7 μm, greater than or equal to 4 μm and less than or equal to 6 μm, or greater than or equal to 4 μm and less than or equal to 5 μm. In some embodiments, the radius R1 of the core region 10 may be greater than or equal to 3 μm, greater than or equal to 3.5 μm, greater than or equal to 4 μm, greater than or equal to 4.5 μm, greater than or equal to 5 μm, greater than or equal to 5.5 μm, greater than or equal to 6 μm, greater than or equal to 6.5 μm, or greater. In some embodiments, the radius R1 of the core region 10 may be less than or equal to 7 μm, less than or equal to 6.5 μm, less than or equal to 6 μm, less than or equal to 5.5 μm, less than or equal to 5 μm, less than or equal to 4.5 μm, less than or equal to 4 μm, less than or equal to 3.5 μm, or less.

The maximum relative refractive index Δ0 or Δ1_{MAX} of the core region 10 may range from about 0.15% to about 0.5%—including all sub-ranges or values therebetween. For example, in some embodiments, the maximum relative refractive index Δ0 or Δ1_{MAX} of the core region 10 may range from about 0.15% to about 0.5%, from about 0.15% to about 0.45%, from about 0.15% to about 0.4%, from about 0.15% to about 0.35%, from about 0.15% to about 0.3%, from about 0.25% to about 0.5%, from about 0.25% to about 0.45%, from about 0.25% to about 0.4%, from about 0.25% to about 0.35%, from about 0.25% to about 0.3%, from about 0.3% to about 0.5%, from about 0.3% to about 0.45%, from about 0.3% to about 0.4%, from about 0.3% to about 0.35%, from about 0.35% to about 0.5%, from about 0.35% to about 0.45%, or from about 0.35% to about 0.4%. In some embodiments, the maximum relative refractive index Δ0 or Δ1_{MAX} of the core region 10 may be greater than or equal to 0.15%, greater than or equal to 0.2%, greater than or equal to 0.25%, greater than or equal to 0.3%, greater than or equal to 0.32%, greater than or equal to 0.34%, greater than or equal to 0.36%, greater than or equal to 0.38%, greater than or equal to 0.4%, greater than or equal to 0.45%, or greater. In some embodiments, the maximum relative refractive index Δ0 or Δ1_{MAX} of the core region 10 may be less than or equal to 0.5%, less than or equal to 0.45%, less than or equal to 0.4%, less than or equal to 0.39%, less than or equal to 0.37%, less than or equal to 0.35%, less than or equal to 0.33%, less than or equal to 0.31%, less than or equal to 0.3%, less than or equal to 0.25%, less than or equal to 0.2%, or less.

Although not depicted in FIG. 2, in some embodiments, the relative refractive index of the core region 10 may have a centerline dip such that the maximum refractive index of the core region 10 and the maximum refractive index of the entire bend-insensitive polarization-maintaining fiber 100 may be located a small distance away from the centerline of the core region 10 rather than at the centerline of the core region 10, as depicted in FIG. 2.

The core region 10 may have a core volume V1 ranging from about 4%-micron² to about 6%-micron²-including all sub-ranges or values therebetween. For example, in some embodiments, the core volume V1 may range from about 4%-micron² to about 6%-micron², from about 4%-micron² to about 5.5%-micron², from about 4%-micron² to about 5.25%-micron², from about 4%-micron² to about 5%-micron², from about 4%-micron² to about 4.75%-micron², from about 4%-micron² to about 4.5%-micron², from about 4%-micron² to about 4.25%-micron², from about 4.25%-micron² to about 6%-micron², from about 4.25%-micron² to about 5.5%-micron², from about 4.25%-micron² to about 5.25%-micron², from about 4.25%-micron² to about 5%-micron², from about 4.25%-micron² to about 4.75%-micron², from about 4.25%-micron² to about 4.5%-micron², from about 4.5%-micron² to about 6%-micron², from about 4.5%-micron² to about 5.5%-micron², from about 4.5%-micron² to about 5.25%-micron², from about 4.5%-micron² to about 5%-micron², from about 4.5%-micron² to about 4.75%-micron², from about 4.75%-micron² to about 6%-micron², from about 4.75%-micron² to about 5.5%-micron², from about 4.75%-micron² to about 5.25%-micron², from about 4.75%-micron² to about 5%-micron², from about 5%-micron² to about 6%-micron², from about 5%-micron² to about 5.5%-micron², or from about 5%-micron² to about 5.25%-micron². In some embodiments, the core volume V1 may be greater than or equal to 4%-micron², greater than or equal to 4.25%-micron², greater than or equal to 4.5%-micron², greater than or equal to 4.75%-micron², greater than or equal to 5%-micron², greater than or equal to 5.25%-micron², greater than or equal to 5.5%-micron², greater than or equal to 5.75%-micron², or greater. In some embodiments, the core volume V1 may be less than or equal to 6%-micron², less than or equal to 5.75%-micron², greater than or equal to 5.5%-micron², greater than or equal to 5.25%-micron², greater than or equal to 5%-micron², greater than or equal to 4.75%-micron², greater than or equal to 4.5%-micron², greater than or equal to 4.25%-micron², or less.

### Inner Cladding Region

In some embodiments, the inner cladding region 40 may include un-doped silica glass. In some embodiments, the inner cladding region 40 may include an inner radius R1 corresponding to the inner radius R1 of the cladding region 20 and corresponding to the radius R1 of the core region 10. The inner cladding region 40 may include an outer radius R2 ranging from about 6 μm to about 14 μm—including all sub-ranges or values therebetween. For example, in some embodiments, the outer radius R2 of the inner cladding region 40 may range from about 6 μm to about 14 μm, from about 6 μm to about 12 μm, from about 6 μm to about 11 μm, from about 6 μm to about 10 μm, from about 6 μm to about 9.5 μm, from about 6 μm to about 9 μm, from about 8 μm to about 14 μm, from about 8 μm to about 12 μm, from about 8 μm to about 11 μm, from about 8 μm to about 10 μm, from about 8 μm to about 9.5 μm, from about 8 μm to about 9 μm, from about 8.5 μm to about 14 μm, from about 8.5 μm to about 12 μm, from about 8.5 μm to about 11 μm, from about 8.5 μm to about 10 μm, from about 8.5 μm to about 9.5 μm, from about 8.5 μm to about 9 μm, from about 9 μm to about 14 μm, from about 9 μm to about 12 μm, from about 9 μm to about 11 μm, from about 9 μm to about 10 μm, from about 9 μm to about 9.5 μm, from about 9.5 μm to about 14 μm, from about 9.5 μm to about 12 μm, from about 9.5 μm to about 11 μm, from about 9.5 μm to about 10 μm, from about 10 μm to about 14 μm, or from about 10 μm to about 12 μm.

In some embodiments, the outer radius R2 of the inner cladding region 40 may be greater than or equal to 6 μm, greater than or equal to 7 μm, greater than or equal to 8 μm, greater than or equal to 8.5 μm, greater than or equal to 9 μm, greater than or equal to 9.5 μm, greater than or equal to 10 μm, greater than or equal to 11 μm, greater than or equal to 12 μm, greater than or equal to 13 μm, or greater. In some embodiments, the outer radius R2 of the inner cladding region 40 may be less than or equal to 14 μm, less than or equal to 13 μm, less than or equal to 12 μm, less than or equal to 11 μm, less than or equal to 10 μm, less than or equal to 9.5 μm, less than or equal to 9 μm, less than or equal to 8 μm, less than or equal to 7 μm, or less.

The relative refractive index Δ2 of the inner cladding region 40 may be in a range from about −0.20% to about 0.20%, or in a range from about −0.15% to about 0.15%, or in a range from about −0.10% to about 0.10%, or in a range from about −0.05% to about 0.05%. In some embodiments, the relative refractive index Δ2 may be about 0.0%. The relative refractive index 42 may be constant or approximately constant.

### Trench Region

The trench region 50 may include down-doped silica glass. In some embodiments, the trench region 50 may be down-doped with fluorine or boron. However, the down-doping of the trench region 50 may also be accomplished by incorporating voids in silica glass.

In some embodiments, the trench region 50 may include an inner radius R2 corresponding to the outer radius R2 of the inner cladding region 40. The trench region 50 may include an outer radius R3 ranging from about 8 μm to about 20 μm-including all sub-ranges or values therebetween. For example, in some embodiments, the outer radius R3 of the trench region 50 may range from about 8 μm to about 20 μm, from about 8 μm to about 17 μm, from about 8 μm to about 15 μm, from about 8 μm to about 14.5 μm, from about 8 μm to about 14 μm, from about 8 μm to about 13.5 μm, from about 8 μm to about 13 μm, from about 8 μm to about 12.5 μm, from about 10 μm to about 20 μm, from about 10 μm to about 17 μm, from about 10 μm to about 15 μm, from about 10 μm to about 14.5 μm, from about 10 μm to about 14 μm, from about 10 μm to about 13.5 μm, from about 10 μm to about 13 μm, from about 10 μm to about 12.5 μm, from about 12 μm to about 20 μm, from about 12 μm to about 17 μm, from about 12 μm to about 15 μm, from about 12 μm to about 14.5 μm, from about 12 μm to about 14 μm, from about 12 μm to about 13.5 μm, from about 12 μm to about 13 μm, from about 12 μm to about 12.5 μm, from about 12.5 μm to about 20 μm, from about 12.5 μm to about 17 μm, from about 12.5 μm to about 15 μm, from about 12.5 μm to about 14.5 μm, from about 12.5 μm to about 14 μm, from about 12.5 μm to about 13.5 μm, from about 12.5 μm to about 13 μm, from about 13 μm to about 20 μm, from about 13 μm to about 17 μm, from about 13 μm to about 15 μm, from about 13 μm to about 14.5 μm, from about 13 μm to about 14 μm, from about 13 μm to about 13.5 μm, from about 13.5 μm to about 20 μm, from about 13.5 μm to about 17 μm, from about 13.5 μm to about 15 μm, from about 13.5 μm to about 14.5 μm, from about 13.5 μm to about 14 μm, from about 14 μm to about 20 μm, from about 14 μm to about 17 μm, from about 14 μm to about 15 μm, or from about 14 μm to about 14.5 μm.

In some embodiments, the outer radius R3 of the trench region 50 may be greater than or equal to 8 μm, greater than or equal to 9 μm, greater than or equal to 10 μm, greater than or equal to 11 μm, greater than or equal to 12 μm, greater than or equal to 12.5 μm, greater than or equal to 13 μm, greater than or equal to 13.5 μm, greater than or equal to 14 μm, greater than or equal to 14.5 μm, greater than or equal to 15 μm, greater than or equal to 15.5 μm, greater than or equal to 16 μm, greater than or equal to 16.5 μm, greater than or equal to 17 μm, greater than or equal to 17.5 μm, greater than or equal to 18 μm, greater than or equal to 19 μm, greater than or equal to 20 μm, or greater. In some embodiments, the outer radius R3 of the trench region 50 may be less than or equal to 20 μm, less than or equal to 18 μm, less than or equal to 17 μm, less than or equal to 16 μm, less than or equal to 15 μm, less than or equal to 14.5 μm, less than or equal to 14 μm, less than or equal to 13.5 μm, less than or equal to 13 μm, less than or equal to 12.5 μm, less than or equal to 12 μm, less than or equal to 11 μm, less than or equal to 10 μm, less than or equal to 9 μm, or less.

In some embodiments, the trench region 50 may be a depressed index cladding region or depressed index trench region. The minimum relative refractive index Δ3 (Δ3_{MIN}) of the trench region 50 may range from about −0.6% to about −0.2%—including all sub-ranges or values therebetween. For example, in some embodiments, the minimum relative refractive index Δ3 (Δ3_{MIN}) of the trench region 50 may range from about −0.6% to about −0.2%, from about −0.6% to about −0.3%, from about −0.6% to about −0.35%, from about −0.6% to about −0.4%, from about-0.6% to about −0.45%, from about −0.6% to about −0.5%, from about −0.5% to about −0.2%, from about −0.5% to about −0.3%, from about −0.5% to about −0.35%, from about −0.5% to about −0.4%, from about −0.5% to about −0.45%, from about −0.45% to about −0.2%, from about −0.45% to about −0.3%, from about −0.45% to about −0.35%, from about −0.45% to about −0.4%, from about −0.4% to about −0.2%, from about −0.4% to about −0.3%, or from about −0.4% to about −0.35%.

In some embodiments, the minimum relative refractive index Δ3 (Δ3_{MIN}) of the trench region 50 may be greater than or equal to −0.6%, greater than or equal to −0.5%, greater than or equal to −0.45%, greater than or equal to −0.4%, greater than or equal to −0.35%, greater than or equal to −0.3%, greater than or equal to −0.25%, or greater. In some embodiments, the minimum relative refractive index Δ3 (Δ3_{MIN}) of the trench region 50 may be less than or equal to −0.2%, less than or equal to −2.5%, less than or equal to −0.3%, less than or equal to −0.35%, less than or equal to −0.4%, less than or equal to −0.45%, less than or equal to −0.5%, less than or equal to −0.55%, or less.

The transition region from the inner cladding region 40 to the trench region 50 is shown as a step change in FIGS. 2, 3A, and 3B. Furthermore, the transition region from the trench region 50 to the outer cladding region 60 is shown as a step change in FIG. 2. However, it is to be understood that the step changes are each an idealization and that the transition regions may not be strictly vertical in practice. Instead, the transition regions may each have a slope or curvature. The trench region 50 may have a square profile, as shown in FIG. 2. However, it is contemplated that the trench region 50 may have other profile configurations.

The trench region 50 may have a trench volume V3 ranging from about −80%-micron² to about −20%-micron²—including all sub-ranges or values therebetween. For example, in some embodiments, the trench volume V3 may range from about −80%-micron² to about −20%-micron², from about −80%-micron² to about −30%-micron², from about −80%-micron² to about-35%-micron², from about −80%-micron² to about −40%-micron², from about −80%-micron² to about −45%-micron², from about −80%-micron² to about −50%-micron², from about −80%-micron² to about −60%-micron², from about −80%-micron² to about −70%-micron², from about −70%-micron² to about −20%-micron², from about −70%-micron² to about −30%-micron², from about-70%-micron² to about −35%-micron², from about −70%-micron² to about −40%-micron², from about −70%-micron² to about −45%-micron², from about −70%-micron² to about −50%-micron², from about −70%-micron² to about −60%-micron², from about −60%-micron² to about −20%-micron², from about −60%-micron² to about −30%-micron², from about −60%-micron² to about-35%-micron², from about −60%-micron² to about −40%-micron², from about −60%-micron² to about −45%-micron², from about −60%-micron² to about −50%-micron², from about −55%-micron² to about −20%-micron², from about −55%-micron² to about −30%-micron², from about −55%-micron² to about −35%-micron², from about −55%-micron² to about −40%-micron², from about-55%-micron² to about −45%-micron², from about −55%-micron² to about −50%-micron², from about −50%-micron² to about −20%-micron², from about −50%-micron² to about −30%-micron², from about −50%-micron² to about −35%-micron², from about −50%-micron² to about −40%-micron², from about −50%-micron² to about −45%-micron², from about −45%-micron² to about-20%-micron², from about −45%-micron² to about −30%-micron², from about −45%-micron² to about −35%-micron², from about −45%-micron² to about −40%-micron², from about −40%-micron² to about −20%-micron², from about −40%-micron² to about −30%-micron², from about −40%-micron² to about −35%-micron², from about −35%-micron² to about −20%-micron², or from about −35%-micron² to about −30%-micron².

In some embodiments, the trench volume V3 may be greater than or equal to −80%-micron², greater than or equal to −70%-micron², greater than or equal to −60%-micron², greater than or equal to −55%-micron², greater than or equal to −50%-micron², greater than or equal to −45%-micron², greater than or equal to −40%-micron², greater than or equal to −35%-micron², greater than or equal to −30%-micron², greater than or equal to −25%-micron², or greater. In some embodiments, the trench volume V3 may be less than or equal to −20%-micron², less than or equal to −25%-micron², less than or equal to −30%-micron², less than or equal to −35%-micron², less than or equal to −40%-micron², less than or equal to −45%-micron², less than or equal to −50%-micron², less than or equal to −55%-micron², less than or equal to −60%-micron², less than or equal to −65%-micron², less than or equal to −70%-micron², less than or equal to −75%-micron², or greater.

Without intending to be bound by theory, the trench volume V3 may have an upper bound of about −20%-sq. microns such that the bend-insensitive polarization-maintaining fiber 100 may be bend-insensitive. Without intending to be bound by theory, the trench volume V3 may further have a lower bound of about −80%-sq. microns so that the bend-insensitive polarization-maintaining fiber 100 may be a single-mode fiber in the target operating window. In some embodiments, the bend-insensitive polarization-maintaining fiber described herein may enable operation in single mode in short-length (e.g., 0.5 m or less) applications in target operating windows of both C-band (1530-1565 nm) and/or O-band (1270-1330 nm).

### Outer Cladding Region

The outer cladding region 60 may include un-doped silica glass. In some embodiments, the outer cladding region 60 may include an inner radius corresponding to the outer radius R3 of the trench region 50. The outer cladding region 60 may include an outer radius R4 corresponding to the outer radius R4 of the cladding region 20 and corresponding to the fiber radius R4. The outer radius R4 of the outer cladding region 60 may range from about 40 μm to about 65 μm-including all sub-ranges or values therebetween. For example, in some embodiments, the outer radius R4 of the outer cladding region 60 may range from about 40 μm to about 65 μm, from about 50 μm to about 65 μm, from about 60 μm to about 65 μm, from about 62 μm to about 63 μm. The outer radius R4 of the outer cladding region 60 may be greater than or equal to 40 μm, greater than or equal to 50 μm, greater than or equal to 60 μm, greater than or equal to 61 μm, greater than or equal to 62 μm, or greater. The outer radius R4 of the outer cladding region 60 may be less than or equal to 65 μm, less than or equal to 64 μm, less than or equal to 63 μm, or less. In some embodiments, the outer radius R4 of the outer cladding region 60 may be about 62.5 μm. The outer cladding region 60 may correspond to the outermost layer of the glass portion of the bend-insensitive polarization-maintaining fibers, and the outer radius R4 of the outer cladding region 60 may also correspond to the radius R4 of the glass fiber.

The relative refractive index 44 of the outer cladding region 60 may be in a range from about −0.20% to about 0.20%, from about −0.15% to about 0.15%, from about −0.10% to about 0.10%, or from about −0.05% to about 0.05%. In some embodiments, the relative refractive index Δ4 may be about 0.0%. The relative refractive index 44 may be preferably constant or approximately constant. Furthermore, in some embodiments, the relative refractive index 44 may be equal to or substantially equal to the relative refractive index 42 of the inner cladding region 40.

### Stress Regions 30a, 30b

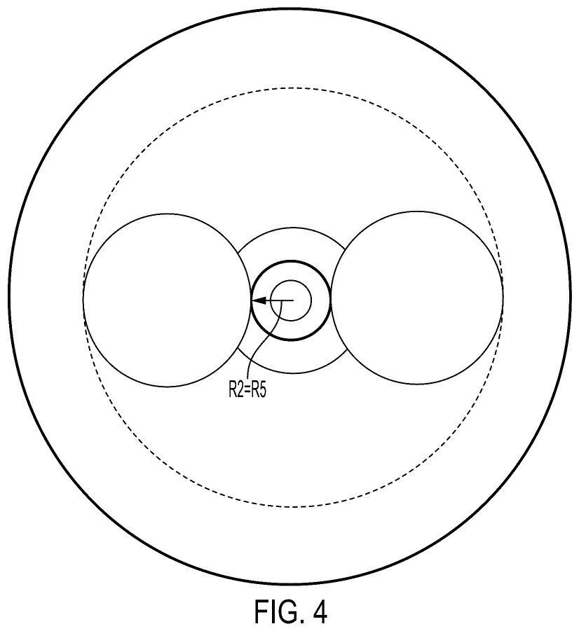

The two stress regions 30a, 30b may be symmetrically positioned with respect to the centerline of the bend-insensitive polarization-maintaining fiber 100. In some embodiments, the stress regions 30a, 30b may be located in an annular region having an inside radius R5 and an outside radius R6. The inside radius R5 of the annular region may be no less than the inner radius R2 of the trench region 50. In some embodiments, the inside radius R5 of the annular region may be greater than the inner radius R2 of the trench region 50, such as in the exemplary bend-insensitive polarization-maintaining fiber 100 shown in FIG. 1. In some embodiments, the inside radius R5 of the annular region may correspond to the inner radius R2 of the trench region 50, such as in the exemplary bend-insensitive polarization-maintaining fiber shown in FIG. 4.

Further, a ratio of the radius R1 of the core region 10 to the inner radius R2 of the trench region 50 may be configured to further ensure that the stress regions 30a, 30b may not encroaching on the inner cladding region 40 of the bend-insensitive polarization-maintaining fiber 100. In some embodiments, the ratio of the radius R1 of the core region 10 to the inner radius R2 of the trench region 50 may range from about 0.4 to about 0.5—including all sub-ranges or values therebetween. For example, in some embodiments, the ratio of the radius R1 of the core region 10 to the inner radius R2 of the trench region 50 may range from about 0.4 to about 0.5, from about 0.4 to about 0.48, from about 0.4 to about 0.46, from about 0.4 to about 0.44, from about 0.4 to about 0.42, from about 0.42 to about 0.5, from about 0.42 to about 0.48, from about 0.42 to about 0.46, from about 0.42 to about 0.44, from about 0.44 to about 0.5, from about 0.44 to about 0.48, from about 0.44 to about 0.46, from about 0.46 to about 0.5, from about 0.46 to about 0.48, or from about 0.48 to about 0.5. In some embodiments, the ratio of the radius R1 of the core region 10 to the inner radius R2 of the trench region 50 may be greater than or equal to 0.4, greater than or equal to 0.41, greater than or equal to 0.42, greater than or equal to 0.43, greater than or equal to 0.44, greater than or equal to 0.45, greater than or equal to 0.46, greater than or equal to 0.47, greater than or equal to 0.48, greater than or equal to 0.49, or greater. In some embodiments, the ratio of the radius R1 of the core region 10 to the inner radius R2 of the trench region 50 may be less than or equal to 0.5, less than or equal to 0.48, less than or equal to 0.47, less than or equal to 0.46, less than or equal to 0.45, less than or equal to 0.44, less than or equal to 0.43, less than or equal to 0.42, less than or equal to 0.41, or less.

Without intending to be bound by theory, when the inside radius R5 of the annular region is greater than or equal to the inner radius R2 of the trench region 50 or a separation between the stress regions 30a, 30b along the slow axis (i.e., 2×R5) is greater than or equal to the inner diameter (i.e., 2×R2) of the trench region 50, the stress regions 30a, 30b may be located outside the inner cladding region 40 between the core region 10 and the trench region 50, and the bend-insensitive polarization-maintaining fiber 100 described herein may enable a uniformly low bend loss between the fast and slow axes when the bend-insensitive polarization-maintaining fiber 100 is bent along either the fast axis or the slow axis.

In some embodiments, the outer radius R3 of the trench region 50 may be greater than or equal to the inside radius R5 of the annular region. In some embodiments, the outer radius R3 of the trench region 50 may also be less than or equal to the outside radius R6 of the annular region. Such configuration may achieve the appropriate trench volume V3, e.g., −80%-micron² to about −20%-micron², so that the bend-insensitive polarization-maintaining fiber 100 may be bend-insensitive while also operating in single mode in the target operating window of, e.g., O-band (1270-1330 nm) and/or C-band (1530-1565 nm).

In some embodiments, the inside radius R5 of the annular region may range from about 6 μm to about 16 μm-including all sub-ranges or values therebetween. For example, in some embodiments, the inside radius R5 of the annular region may range from about 6 μm to about 16 μm, from about 6 μm to about 14 μm, from about 6 μm to about 12 μm, from about 6 μm to about 11 μm, from about 6 μm to about 10 μm, from about 6 μm to about 8 μm, from about 8 μm to about 16 μm, from about 8 μm to about 14 μm, from about 8 μm to about 12 μm, from about 8 μm to about 11 μm, from about 8 μm to about 10 μm, from about 10 μm to about 16 μm, from about 10 μm to about 14 μm, from about 10 μm to about 12 μm, from about 10 μm to about 11 μm, from 11 μm to about 16 μm, from 11 μm to about 14 μm, from about 11 μm to about 12 μm, from 12 μm to about 16 μm, from 12 μm to about 14 μm, or from about 14 μm to about 16 μm.

In some embodiments, the inside radius R5 of the annular region may be greater than or equal to 6 μm, greater than or equal to 7 μm, greater than or equal to 8 μm, greater than or equal to 9 μm, greater than or equal to 10 μm, greater than or equal to 11 μm, greater than or equal to 12 μm, greater than or equal to 13 μm, greater than or equal to 14 μm, greater than or equal to 15 μm, greater than or equal to 16 μm, or greater. In some embodiments, the inside radius R5 of the annular region may be less than or equal to 16 μm, less than or equal to 15 μm, less than or equal to 14 μm, less than or equal to 13 μm, less than or equal to 12 μm, less than or equal to 11 μm, less than or equal to 10 μm, less than or equal to 9 μm, less than or equal to 8 μm, less than or equal to 7 μm, or less.

The separation of the stress regions 30a, 30b along the slow axis (i.e., 2×R5) may range from about 12 μm to about 32 μm-including all sub-ranges or values therebetween. For example, in some embodiments, the separation of the stress regions 30a, 30b along the slow axis (i.e., 2×R5) may range from about 12 μm to about 32 μm, from about 12 μm to about 28 μm, from about 12 μm to about 24 μm, from about 12 μm to about 20 μm, from about 12 μm to about 16 μm, from about 16 μm to about 32 μm, from about 16 μm to about 28 μm, from about 16 μm to about 24 μm, from about 16 μm to about 20 μm, from about 20 μm to about 32 μm, from about 20 μm to about 28 μm, from about 20 μm to about 24 μm, from about 24 μm to about 32 μm, from about 24 μm to about 28 μm, or from about 28 μm to about 32 μm.

In some embodiments, the separation of the stress regions 30a, 30b along the slow axis (i.e., 2×R5) may be greater than or equal to 12 μm, greater than or equal to 14 μm, greater than or equal to 16 μm, greater than or equal to 18 μm, greater than or equal to 20 μm, greater than or equal to 22 μm, greater than or equal to 24 μm, greater than or equal to 26 μm, greater than or equal to 28 μm, greater than or equal to 30 μm, greater than or equal to 32 μm, or greater. In some embodiments, the separation of the stress regions 30a, 30b(i.e., 2×R5) may be less than or equal to 32 μm, less than or equal to 30 μm, less than or equal to 28 μm, less than or equal to 26 μm, less than or equal to 24 μm, less than or equal to 22 μm, less than or equal to 20 μm, less than or equal to 18 μm, less than or equal to 16 μm, less than or equal to 14 μm, or less.

In some embodiments, the outside radius R6 of the annular region may range from about 30 μm to about 55 μm—including all sub-ranges or values therebetween. For example, in some embodiments, the outside radius R6 of the annular region may range from about 30 μm to about 55 μm, from about 30 μm to about 52.5 μm, from about 30 μm to about 50 μm, from about 30 μm to about 47.5 μm, from about 30 μm to about 45 μm, from about 30 μm to about 42.5 μm, from about 30 μm to about 40 μm, from about 30 μm to about 37.5 μm, from about 30 μm to about 35 μm, from about 30 μm to about 32.5 μm, from about 32.5 μm to about 55 μm, from about 32.5 μm to about 52.5 μm, from about 32.5 μm to about 50 μm, from about 32.5 μm to about 47.5 μm, from about 32.5 μm to about 45 μm, from about 32.5 μm to about 42.5 μm, from about 32.5 μm to about 40 μm, from about 32.5 μm to about 37.5 μm, from about 32.5 μm to about 35 μm, from about 35 μm to about 55 μm, from about 35 μm to about 52.5 μm, from about 35 μm to about 50 μm, from about 35 μm to about 47.5 μm, from about 35 μm to about 45 μm, from about 35 μm to about 42.5 μm, from about 35 μm to about 40 μm, from about 35 μm to about 37.5 μm, from about 37.5 μm to about 55 μm, from about 37.5 μm to about 52.5 μm, from about 37.5 μm to about 50 μm, from about 37.5 μm to about 47.5 μm, from about 37.5 μm to about 45 μm, from about 37.5 μm to about 42.5 μm, from about 37.5 μm to about 40 μm, from about 40 μm to about 55 μm, from about 40 μm to about 52.5 μm, from about 40 μm to about 50 μm, from about 40 μm to about 47.5 μm, from about 40 μm to about 45 μm, from about 40 μm to about 42.5 μm, from about 42.5 μm to about 55 μm, from about 42.5 μm to about 52.5 μm, from about 42.5 μm to about 50 μm, from about 42.5 μm to about 47.5 μm, from about 42.5 μm to about 45 μm, from about 45 μm to about 55 μm, from about 45 μm to about 52.5 μm, from about 45 μm to about 50 μm, from about 45 μm to about 47.5 μm, from about 47.5 μm to about 55 μm, from about 47.5 μm to about 52.5 μm, from about 47.5 μm to about 50 μm, from about 50 μm to about 55 μm, from about 50 μm to about 52.5 μm, or from about 52.5 μm to about 55 μm.

In some embodiments, the outside radius R6 of the annular region may be greater than or equal to 30 μm, greater than or equal to 32.5 μm, greater than or equal to 35 μm, greater than or equal to 37.5 μm, greater than or equal to 40 μm, greater than or equal to 42.5 μm, greater than or equal to 45 μm, greater than or equal to 47.5 μm, greater than or equal to 50 μm, greater than or equal to 52.5 μm, or greater. In some embodiments, the outside radius R6 of the annular region may be less than or equal to 55 μm, less than or equal to 52.5 μm, less than or equal to 50 μm, less than or equal to 47.5 μm, less than or equal to 45 μm, less than or equal to 42.5 μm, less than or equal to 40 μm, less than or equal to 37.5 μm, less than or equal to 35 μm, less than or equal to 32.5 μm, or less.

The bend-insensitive polarization-maintaining fiber 100 may include a minimum distance between the periphery of the outer cladding region 60 and the periphery of the stress regions 30a, 30b along the slow axis (i.e., R4-R6), which may also be referred to the minimum cladding thickness Tc_{MIN}(C) of the outer cladding region 60 along the slow axis. The minimum cladding thickness (Tc_{MIN}(C)=R4-R6) along the slow axis may range from about 10 μm to about 20 μm-including all sub-ranges or values therebetween. For example, in some embodiments, the minimum cladding thickness (Tc_{MIN}(C)=R4-R6) along the slow axis may range from about 10 μm to about 20 μm, from about 10 μm to about 18 μm, from about 10 μm to about 16 μm, from about 10 μm to about 14 μm, from about 10 μm to about 12 μm, from about 12 μm to about 20 μm, from about 12 μm to about 18 μm, from about 12 μm to about 16 μm, from about 12 μm to about 14 μm, from about 14 μm to about 20 μm, from about 14 μm to about 18 μm, from about 14 μm to about 16 μm, from about 16 μm to about 20 μm, from about 16 μm to about 18 μm, or from about 18 μm to about 20 μm.

In some embodiments, the minimum cladding thickness (Tc_{MIN}(C)=R4−R6) along the slow axis may be greater than or equal to 10 μm, greater than or equal to 11 μm, greater than or equal to 12 μm, greater than or equal to 13 μm, greater than or equal to 14 μm, greater than or equal to 15 μm, greater than or equal to 16 μm, greater than or equal to 17, greater than or equal to 18, greater than or equal to 19, or greater. In some embodiments, the minimum cladding thickness (Tc_{MIN}(C)=R4-R6) along the slow axis may be less than or equal to 20 μm, less than or equal to 19 μm, less than or equal to 18 μm, less than or equal to 17 μm, less than or equal to 16 μm, less than or equal to 15 μm, less than or equal to 14 μm, less than or equal to 13 μm, less than or equal to 12 μm, less than or equal to 11 μm, or less. The minimum cladding thickness (Tc_{MIN}(C)=R4−R6) along the slow axis described herein may allow for greater diameter of the stress regions 30a, 30b to be implemented while also maintaining the integrity of the outer cladding region 60 and the bend-insensitive polarization-maintaining fiber 100.

In some embodiments, each of the stress regions 30a, 30b may include a circular region. In some embodiments, the stress regions 30a, 30b may have a diameter Ds(C) range from about 30 μm to about 45 μm—including all sub-ranges or values therebetween. For example, in some embodiments, the diameter Ds(C) of the stress regions 30a, 30b may range from about 30 μm to about 45 μm, from about 30 μm to about 42.5 μm, from about 30 μm to about 40 μm, from about 30 μm to about 37.5 μm, from about 30 μm to about 35 μm, from about 30 μm to about 32.5 μm, from about 32.5 μm to about 45 μm, from about 32.5 μm to about 42.5 μm, from about 32.5 μm to about 40 μm, from about 32.5 μm to about 37.5 μm, from about 32.5 μm to about 35 μm, from about 35 μm to about 45 μm, from about 35 μm to about 42.5 μm, from about 35 μm to about 40 μm, from about 35 μm to about 37.5 μm, from about 37.5 μm to about 45 μm, from about 37.5 μm to about 42.5 μm, from about 37.5 μm to about 40 μm, from about 40 μm to about 45 μm, from about 40 μm to about 42.5 μm, from about 42.5 μm to about 45 μm.

In some embodiments, the diameter Ds(C) of the stress regions 30a, 30b may be greater than or equal to 30 μm, greater than or equal to 32.5 μm, greater than or equal to 35 μm, greater than or equal to 35.5 μm, greater than or equal to 36 μm, greater than or equal to 36.5 μm, greater than or equal to 37 μm, greater than or equal to 37.5 μm, greater than or equal to 38 μm, greater than or equal to 38.5 μm, greater than or equal to 39 μm, greater than or equal to 39.5 μm, greater than or equal to 40 μm, greater than or equal to 42.5 μm, or greater. In some embodiments, the diameter Ds(C) of the stress regions 30a, 30b may be less than or equal to 45 μm, less than or equal to 42.5 μm, less than or equal to 40 μm, less than or equal to 39.5 μm, less than or equal to 39 μm, less than or equal to 38.5 μm, less than or equal to 38 μm, less than or equal to 37.5 μm, less than or equal to 37 μm, less than or equal to 36.5 μm, less than or equal to 36 μm, less than or equal to 35.5 μm, less than or equal to 35 μm, less than or equal to 32.5 μm, or less.

The centers of the stress regions 30a, 30b may be located at a distance D(C) from the centerline of the bend-insensitive polarization-maintaining fiber 100. In some embodiments, the distance D(C) between the centerline of the bend-insensitive polarization-maintaining fiber 100 and the centers of the stress regions 30a, 30b may range from about 25 μm to about 35 μm-including all sub-ranges or values therebetween. For example, in some embodiments, the distance D(C) between the centerline of the bend-insensitive polarization-maintaining fiber 100 and the centers of the stress regions 30a, 30b may range from about 25 μm to about 35 μm, from about 25 μm to about 32.5 μm, from about 25 μm to about 30 μm, from about 25 μm to about 27.5 μm, from about 27.5 μm to about 35 μm, from about 27.5 μm to about 32.5 μm, from about 27.5 μm to about 30 μm, from about 30 μm to about 35 μm, from about 30 μm to about 32.5 μm, or from about 32.5 μm to about 35 μm.

In some embodiments, the distance D(C) between the centerline of the bend-insensitive polarization-maintaining fiber 100 and the centers of the stress regions 30a, 30b may be greater than or equal to 25 μm, greater than or equal to 27 μm, greater than or equal to 29 μm, greater than or equal to 31 μm, greater than or equal to 33 μm, greater than or equal to 35 μm, or greater. In some embodiments, the distance D(C) between the centerline of the bend-insensitive polarization-maintaining fiber 100 and the centers of the stress regions 30a, 30b may be less than or equal to 35 μm, less than or equal to 34 μm, less than or equal to 32 μm, less than or equal to 30 μm, less than or equal to 28 μm, less than or equal to 26 μm, less than or equal to 25 μm, or less.

In some embodiments, the stress regions 30a, 30b may include down-doped silica glass. In some embodiments, the stress regions 30a, 30b may include silica glass doped with boron. In some embodiments, the boron doping concentration, as measured in B₂O₃ weight percent unless otherwise specified, may range from about 14 wt. % to about 24 wt. %—including all sub-ranges or values therebetween. For example, in some embodiments, the boron doping concentration may range from about 14 wt. % to about 24 wt. %, from about 14 wt. % to about 22 wt. %, from about 14 wt. % to about 20 wt. %, from about 14 wt. % to about 18 wt. %, from about 14 wt. % to about 16 wt. %, from about 16 wt. % to about 24 wt. %, from about 16 wt. % to about 22 wt. %, from about 16 wt. % to about 20 wt. %, from about 16 wt. % to about 18 wt. %, from about 18 wt. % to about 24 wt. %, from about 18 wt. % to about 22 wt. %, from about 18 wt. % to about 20 wt. %, from about 20 wt. % to about 24 wt. %, from about 20 wt. % to about 22 wt. %, or from about 22 wt. % to about 24 wt. %.

In some embodiments, the boron doping concentration may be greater than or equal to 14 wt. %, greater than or equal to 16 wt. %, greater than or equal to 18 wt. %, greater than or equal to 20 wt. %, greater than or equal to 22 wt. %, greater than or equal to 24 wt. %, or greater. In some embodiments, the boron doping concentration may be less than or equal to 24 wt. %, less than or equal to 22 wt. %, less than or equal to 20 wt. %, less than or equal to 18 wt. %, less than or equal to 16 wt. %, less than or equal to 14 wt. %, or less.

Depending on the boron doping concentration, the minimum relative refractive index Δ5 (Δ5_{MIN}) of the stress regions 30a, 30b may range from about −0.6% to about −0.3%-including all sub-ranges or values therebetween. For example, in some embodiments, the minimum relative refractive index Δ5 (Δ5_{MIN}) of the stress regions 30a, 30b may range from about −0.6% to about −0.3%, from about −0.6% to about −0.35%, from about −0.6% to about −0.4%, from about-0.6% to about −0.45%, from about −0.6% to about −0.5%, from about −0.6% to about −0.55%, from about −0.55% to about −0.3%, from about −0.55% to about −0.35%, from about −0.55% to about-0.4%, from about −0.55% to about −0.45%, from about −0.55% to about −0.5%, from about −0.5% to about −0.3%, from about −0.5% to about −0.35%, from about −0.5% to about −0.4%, from about −0.5% to about −0.45%, from about −0.45% to about −0.3%, from about −0.45% to about −0.35%, from about −0.45% to about −0.4%, from about −0.4% to about −0.3%, from about −0.4% to about-0.35%, or from about −0.35% to about −0.3%.

In some embodiments, the minimum relative refractive index Δ5 (Δ5_{MIN}) of the stress regions 30a, 30b may be greater than or equal to −0.6%, greater than or equal to −0.55%, greater than or equal to −0.5%, greater than or equal to −0.45%, greater than or equal to −0.4%, greater than or equal to −0.35%, greater than or equal to −0.3%, or greater. In some embodiments, the minimum relative refractive index Δ5 (Δ5_{MIN}) of the stress regions 30a, 30b may be less than or equal to −0.3%, less than or equal to −0.35%, less than or equal to −0.4%, less than or equal to −0.45%, less than or equal to −0.5%, less than or equal to −0.55%, less than or equal to −0.6%, or less.

### Stress Regions 70a, 70b

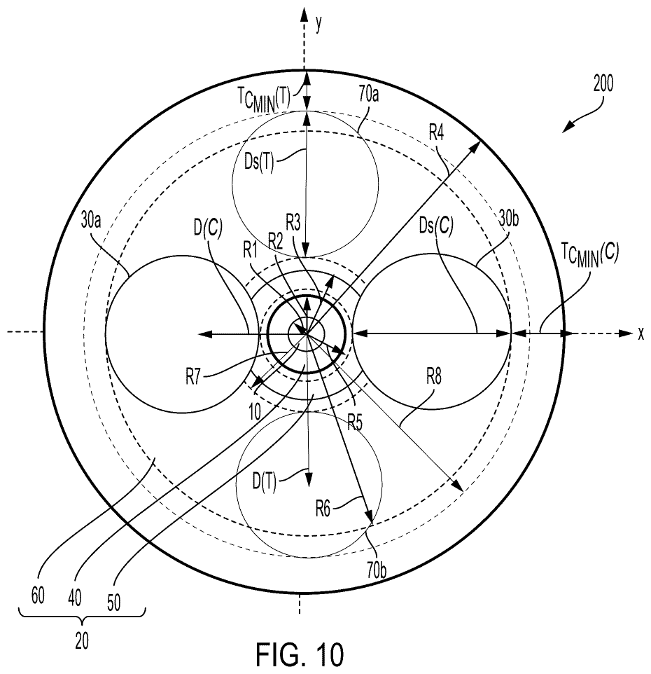

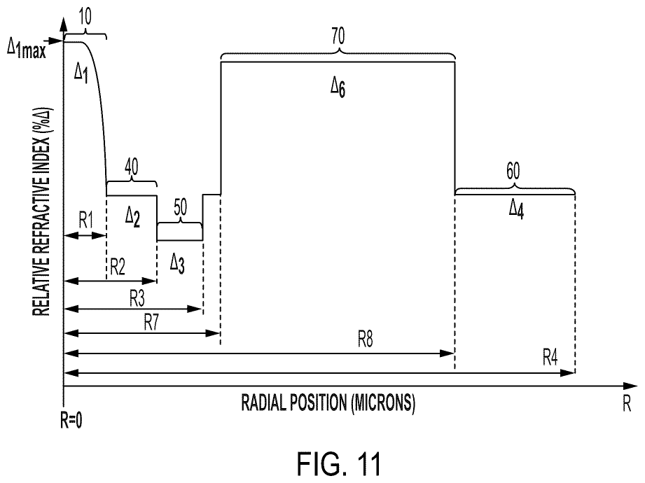

FIG. 10 schematically illustrates another exemplary bend-insensitive polarization-maintaining fiber 200. The bend-insensitive polarization-maintaining fiber 200 is similar to the bend-insensitive polarization-maintaining fiber 100 described above with reference to FIG. 1, except that the bend-insensitive polarization-maintaining fiber 200 further includes two stress regions 70a, 70b. Thus, the descriptions regarding the core region 10, the cladding region 20, the inner cladding region 40, the trench region 50, the outer cladding region 60, and the stress regions 30a, 30b are not repeated. FIG. 11 plots a schematic (not to scale) exemplary relative refractive index profile of the bend-insensitive polarization-maintaining fiber 200 taken along the fast axis (y axis in FIG. 10) of the bend-insensitive polarization-maintaining fiber 200. The stress regions 70a, 70b each have a relative refractive index Δ6, with a maximum value Δ6_{MAX}. In some embodiments, Δ6_{MAX}>44. In some embodiments, Δ6_{MAX}≤Δ1_{MAX}, while in some embodiments, Δ6_{MAX}≥Δ1_{MAX} depending on the particular fiber design, such as dopant concentration implemented in the stress regions 70a, 70b as will be discussed further below.

The two stress regions 70a, 70b may each be configured to create tensile stress on the core region 10. The two stress regions 70a, 70b may be symmetrically positioned with respect to the centerline of the bend-insensitive polarization-maintaining fiber 100. The centers of both stress regions 70a, 70b are located on the fast axis of the bend-insensitive polarization-maintaining fiber 200. In some embodiments, the stress regions 70a, 70b may be located in an annular region having an inside radius R7 and an outside radius R8. In some embodiments, the inside radius R7 of the annular region may be greater than the inside radius R2 of the trench region 50.

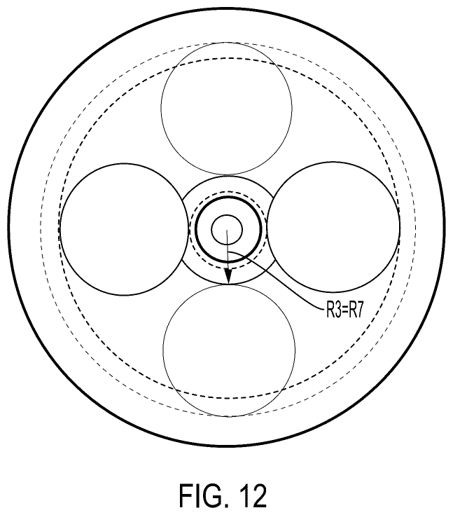

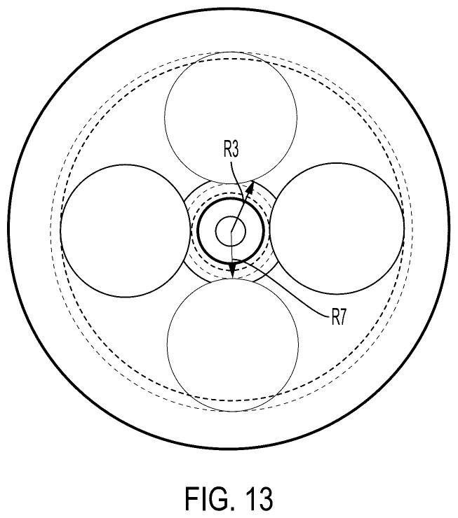

In some embodiments, the inside radius R7 of the annular region may be greater than the outer radius R3 of the trench region 50, such as in the exemplary bend-insensitive polarization-maintaining fiber 200 shown in FIG. 10. Thus, a separation between the stress regions 70a, 70b along the fast axis (i.e., 2×R7) may be greater than the outer diameter of the trench region 50 (2×R3), and the stress regions 70a, 70b may be disposed outside the trench region 50. In some embodiments, the inside radius R7 of the annular region may correspond to the outer radius R3 of the trench region 50, such as in the exemplary bend-insensitive polarization-maintaining fiber shown in FIG. 12. In some embodiments, the inside radius R7 of the annular region may be less than the outer radius R3 of the trench region 50, such as in the exemplary bend-insensitive polarization-maintaining fiber shown in FIG. 13.

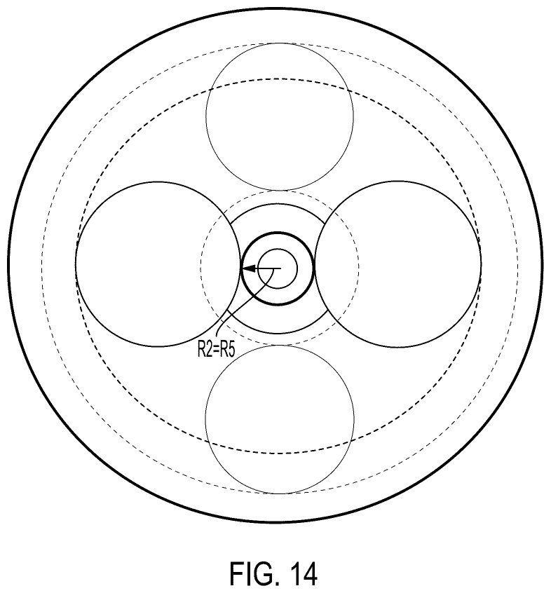

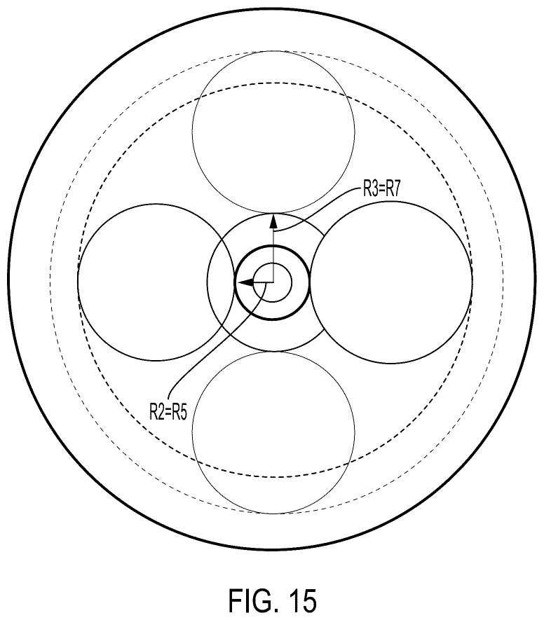

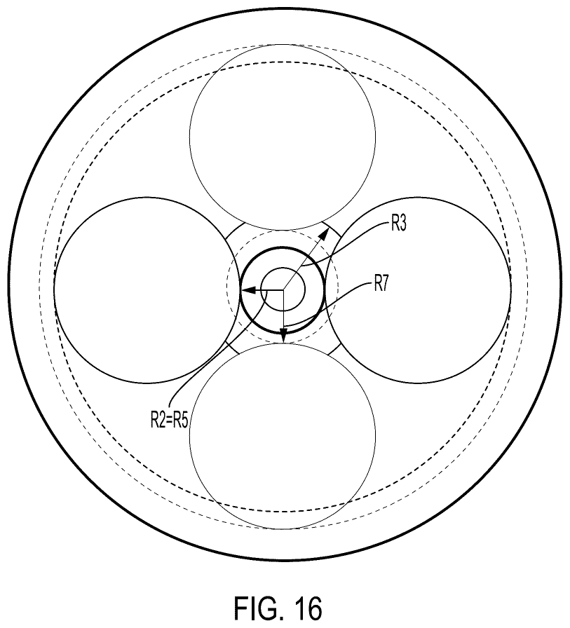

Similar to the bend-insensitive polarization-maintaining fiber 100 described above, in some embodiments, the inside radius R5 of the annular region within which the stress regions 30a, 30b are disposed may be greater than the inner radius R2 of the trench region 50, such as in the exemplary bend-insensitive polarization-maintaining fibers shown in FIGS. 10, 12, and 13, while in other embodiments, the inside radius R5 of the annular region within which the stress regions 30a, 30b are disposed may correspond to the inner radius R2 of the trench region 50, such as in the exemplary bend-insensitive polarization-maintaining fibers shown in FIGS. 14, 15, and 16.

The stress regions 70a, 70b may each be doped with titania (TiO₂). Without intending to be bound by theory, the titania-doped stress regions 70a, 70b can have a higher refractive index than pure silica, and thus can function as waveguides. To minimize the risk of siphoning power from the fast LP01 mode from the core region 10, in some embodiments, the titania-doped stress regions 70a, 70b may be positioned outside of the outer radius R3 of the trench region 50. However, acceptable performance may still be achieved when the stress regions 70a, 70b may extend slightly into the trench region 50.

In some embodiments, the inside radius R7 of the annular region may range from about 12 μm to about 15 μm—including all sub-ranges or values therebetween. For example, in some embodiments, in some embodiments, the inside radius R7 of the annular region may range from about 12 μm to about 15 μm, from about 12 μm to about 14 μm, from about 12 μm to about 13 μm, from about 13 μm to about 15 μm, from about 13 μm to about 14 μm, or from about 14 μm to about 15 μm. In some embodiments, the inside radius R7 of the annular region may be greater than or equal to 12 μm, greater than or equal to 12.5 μm, greater than or equal to 13 μm, greater than or equal to 13.5 μm, greater than or equal to 14 μm, greater than or equal to 14.5 μm, or greater. In some embodiments, the inside radius R7 of the annular region may be less than or equal to 15 μm, less than or equal to 14.5 μm, less than or equal to 14 μm, less than or equal to 13.5 μm, less than or equal to 13 μm, less than or equal to 12.5 μm, or less. In some embodiments, the inside radius R7 of the annular region within which the stress regions 70a, 70b may be disposed may be greater than the inside radius R5 of the annular region within which the stress regions 30a, 30b may be disposed.

In some embodiments, the separation of the stress regions 70a, 70b along the fast axis (i.e., 2×R7) may range from about 24 μm to about 30 μm-including all sub-ranges or values therebetween. For example, in some embodiments, the separation of the stress regions 70a, 70b along the fast axis (i.e., 2×R7) may range from about 24 μm to about 30 μm, from about 24 μm to about 28 μm, from about 24 μm to about 26 μm, from about 26 μm to about 30 μm, from about 26 μm to about 28 μm, or from about 28 μm to about 30 μm. In some embodiments, the separation of the stress regions 70a, 70b along the fast axis (i.e., 2×R7) may be greater than or equal to 24 μm, greater than or equal to 25 μm, greater than or equal to 26 μm, greater than or equal to 27 μm, greater than or equal to 28 μm, greater than or equal to 29 μm, or greater. In some embodiments, the separation of the stress regions 70a, 70b along the fast axis (i.e., 2×R7) may be less than or equal to 30 μm, less than or equal to 29 μm, less than or equal to 28 μm, less than or equal to 27 μm, less than or equal to 26 μm, less than or equal to 25 μm, or less. In some embodiments, the separation of the stress regions 70a, 70b along the fast axis (2×R7) may be greater than the separation of the stress regions 30a, 30b along the slow axis (2×R5).

In some embodiments, the outside radius R8 of the annular region may range from about 42 μm to about 56 μm-including all sub-ranges or values therebetween. For example, in some embodiments, the outside radius R8 of the annular region may range from about 42 μm to about 56 μm, from about 42 μm to about 53 μm, from about 42 μm to about 50 μm, from about 42 μm to about 47 μm, from about 42 μm to about 44 μm, from about 44 μm to about 56 μm, from about 44 μm to about 53 μm, from about 44 μm to about 50 μm, from about 44 μm to about 47 μm, from about 47 μm to about 56 μm, from about 47 μm to about 53 μm, from about 47 μm to about 50 μm, from about 50 μm to about 56 μm, from about 50 μm to about 53 μm, or from about 53 μm to about 56 μm. In some embodiments, the outside radius R8 of the annular region may be greater than or equal to 42 μm, greater than or equal to 43 μm, greater than or equal to 44 μm, greater than or equal to 45 μm, greater than or equal to 46 μm, greater than or equal to 47 μm, greater than or equal to 48 μm, greater than or equal to 49 μm, greater than or equal to 50 μm, greater than or equal to 51 μm, greater than or equal to 52 μm, greater than or equal to 53 μm, greater than or equal to 54 μm, greater than or equal to 55 μm, or greater. In some embodiments, the outside radius R8 of the annular region may be less than or equal to 56 μm, less than or equal to 55 μm, less than or equal to 54 μm, less than or equal to 53 μm, less than or equal to 52 μm, less than or equal to 51 μm, less than or equal to 50 μm, less than or equal to 49 μm, less than or equal to 48 μm, less than or equal to 47 μm, less than or equal to 46 μm, less than or equal to 45 μm, less than or equal to 44 μm, less than or equal to 43 μm, or less.

The bend-insensitive polarization-maintaining fiber 200 may include a minimum distance between the periphery of the outer cladding region 60 and the periphery of the stress regions 70a, 70b along the fast axis (i.e., R4-R8), which may also be referred to the minimum cladding thickness Tc_{MIN}(T) of the outer cladding region 60 along the fast axis. The minimum cladding thickness (Tc_{MIN}(T)=R4-R8) along the fast axis may range from about 6 μm to about 21 μm-including all sub-ranges or values therebetween. For example, in some embodiments, the minimum cladding thickness (Tc_{MIN}(T)=R4-R8) along the fast axis may range from about 6 μm to about 21 μm, from about 6 μm to about 18 μm, from about 6 μm to about 15 μm, from about 6 μm to about 12 μm, from about 6 μm to about 9 μm, from about 9 μm to about 21 μm, from about 9 μm to about 18 μm, from about 9 μm to about 15 μm, from about 9 μm to about 12 μm, from about 12 μm to about 21 μm, from about 12 μm to about 18 μm, from about 12 μm to about 15 μm, from about 15 μm to about 21 μm, from about 15 μm to about 18 μm, or from about 18 μm to about 21 μm. In some embodiments, the minimum cladding thickness (Tc_{MIN}(T)=R4-R8) along the fast axis may be greater than or equal to 6 μm, greater than or equal to 8 μm, greater than or equal to 10 μm, greater than or equal to 12 μm, greater than or equal to 14 μm, greater than or equal to 16 μm, greater than or equal to 18 μm, greater than or equal to 20 μm, or greater. In some embodiments, the minimum cladding thickness (Tc_{MIN}(T)=R4-R8) along the fast axis may be less than or equal to 21 μm, less than or equal to 19 μm, less than or equal to 17 μm, less than or equal to 15 μm, less than or equal to 13 μm, less than or equal to 11 μm, less than or equal to 9 μm, less than or equal to 7 μm, or less. The minimum cladding thickness (Tc_{MIN}(T)=R4−R8) along the fast axis described herein may allow for greater diameter of the stress regions 70a, 70b to be implemented while also maintaining the integrity of the outer cladding region 60 and the bend-insensitive polarization-maintaining fiber 200.

In some embodiments, each of the stress regions 70a, 70b may include a circular region. In some embodiments, the stress regions 70a, 70b may have a diameter Ds(T) range from about 30 μm to about 45 μm—including all sub-ranges or values therebetween. For example, in some embodiments, the diameter Ds(T) of the stress regions 70a, 70b may range from about 30 μm to about 45 μm, from about 30 μm to about 42.5 μm, from about 30 μm to about 40 μm, from about 30 μm to about 37.5 μm, from about 30 μm to about 35 μm, from about 30 μm to about 32.5 μm, from about 32.5 μm to about 45 μm, from about 32.5 μm to about 42.5 μm, from about 32.5 μm to about 40 μm, from about 32.5 μm to about 37.5 μm, from about 32.5 μm to about 35 μm, from about 35 μm to about 45 μm, from about 35 μm to about 42.5 μm, from about 35 μm to about 40 μm, from about 35 μm to about 37.5 μm, from about 37.5 μm to about 45 μm, from about 37.5 μm to about 42.5 μm, from about 37.5 μm to about 40 μm, from about 40 μm to about 45 μm, from about 40 μm to about 42.5 μm, from about 42.5 μm to about 45 μm.

In some embodiments, the diameter Ds(T) of the stress regions 70a, 70b may be greater than or equal to 30 μm, greater than or equal to 32.5 μm, greater than or equal to 35 μm, greater than or equal to 35.5 μm, greater than or equal to 36 μm, greater than or equal to 36.5 μm, greater than or equal to 37 μm, greater than or equal to 37.5 μm, greater than or equal to 38 μm, greater than or equal to 38.5 μm, greater than or equal to 39 μm, greater than or equal to 39.5 μm, greater than or equal to 40 μm, greater than or equal to 42.5 μm, or greater. In some embodiments, the diameter Ds(T) of the stress regions 70a, 70b may be less than or equal to 45 μm, less than or equal to 42.5 μm, less than or equal to 40 μm, less than or equal to 39.5 μm, less than or equal to 39 μm, less than or equal to 38.5 μm, less than or equal to 38 μm, less than or equal to 37.5 μm, less than or equal to 37 μm, less than or equal to 36.5 μm, less than or equal to 36 μm, less than or equal to 35.5 μm, less than or equal to 35 μm, less than or equal to 32.5 μm, or less.

The centers of the stress regions 70a, 70b may be located at a distance D(T) from the centerline of the bend-insensitive polarization-maintaining fiber 200. In some embodiments, the distance D(T) between the centerline of the bend-insensitive polarization-maintaining fiber 200 and the centers of the stress regions 70a, 70b may range from about 25 μm to about 35 μm—including all sub-ranges or values therebetween. For example, in some embodiments, the distance D(T) between the centerline of the bend-insensitive polarization-maintaining fiber 200 and the centers of the stress regions 70a, 70b may range from about 25 μm to about 35 μm, from about 25 μm to about 32.5 μm, from about 25 μm to about 30 μm, from about 25 μm to about 27.5 μm, from about 27.5 μm to about 35 μm, from about 27.5 μm to about 32.5 μm, from about 27.5 μm to about 30 μm, from about 30 μm to about 35 μm, from about 30 μm to about 32.5 μm, or from about 32.5 μm to about 35 μm.

In some embodiments, the distance D(T) between the centerline of the bend-insensitive polarization-maintaining fiber 200 and the centers of the stress regions 70a, 70b may be greater than or equal to 25 μm, greater than or equal to 27 μm, greater than or equal to 29 μm, greater than or equal to 31 μm, greater than or equal to 33 μm, greater than or equal to 35 μm, or greater. In some embodiments, the distance D(T) between the centerline of the bend-insensitive polarization-maintaining fiber 200 and the centers of the stress regions 70a, 70b may be less than or equal to 35 μm, less than or equal to 34 μm, less than or equal to 32 μm, less than or equal to 30 μm, less than or equal to 28 μm, less than or equal to 26 μm, less than or equal to 25 μm, or less.

In some embodiments, the stress regions 70a, 70b may include up-doped silica glass. In some embodiments, the stress regions 70a, 70b may include silica glass doped with titania. In some embodiments, the titania doping concentration, as measured in TiO₂ weight percent unless otherwise specified, may range from about 5 wt. % to about 12 wt. %—including all sub-ranges or values therebetween. For example, in some embodiments, the titania doping concentration may range from about 5 wt. % to about 12 wt. %, from about 5 wt. % to about 10 wt. %, from about 5 wt. % to about 8 wt. %, from about 5 wt. % to about 6 wt. %, from about 6 wt. % to about 12 wt. %, from about 6 wt. % to about 10 wt. %, from about 6 wt. % to about 8 wt. %, from about 8 wt. % to about 12 wt. %, from about 8 wt. % to about 10 wt. %, or from about 10 wt. % to about 12 wt. %. In some embodiments, the titania doping concentration may be greater than or equal to 5 wt. %, greater than or equal to 6 wt. %, greater than or equal to 7 wt. %, greater than or equal to 8 wt. %, greater than or equal to 9 wt. %, greater than or equal to 10 wt. %, greater than or equal to 11 wt. %, or greater. In some embodiments, the titania doping concentration may be less than or equal to 12 wt. %, less than or equal to 11 wt. %, less than or equal to 10 wt. %, less than or equal to 9 wt. %, less than or equal to 8 wt. %, less than or equal to 7 wt. %, less than or equal to 6 wt. %, or less.

Depending on the titania doping concentration, the maximum relative refractive index Δ6 (Δ6_{MAX}) of the stress regions 70a, 70b may range from about 1.2% to about 3.0%-including all sub-ranges or values therebetween. For example, in some embodiments, the maximum relative refractive index Δ6 (Δ6_{MAX}) of the stress regions 70a, 70b may range from about 1.2% to about 3.0%, from about 1.2% to about 2.4%, from about 1.2% to about 1.8%, from about 1.8% to about 3.0%, from about 1.8% to about 2.4%, or from about 2.4% to about 3.0%. In some embodiments, the maximum relative refractive index Δ6 (Δ6_{MAX}) of the stress regions 70a, 70b may be greater than or equal to 1.2%, greater than or equal to 1.6%, greater than or equal to 1.8%, greater than or equal to 2%, greater than or equal to 2.2%, greater than or equal to 2.4%, greater than or equal to 2.6%, greater than or equal to 2.8%, or greater. In some embodiments, the maximum relative refractive index Δ6 (Δ6_{MAX}) of the stress regions 70a, 70b may be less than or equal to 3.0%, less than or equal to 2.8%, less than or equal to 2.6%, less than or equal to 2.4%, less than or equal to 2.2%, less than or equal to 2%, less than or equal to 1.8%, less than or equal to 1.6%, less than or equal to 1.4%, or less.

By having titania-doped stress regions 70a, 70b to create tensile stress on the core region 10 along the fast axis, the boron-doped stress regions 30a, 30b along the slow axis may include a boron doping concentration less than that of the boron-doped stress regions 30a, 30b in the bend-insensitive polarization-maintaining fiber 100 containing no titania-doped stress regions 70a, 70b while still creating enough compressive stress on the core region 10 for the beat length between the fast and slow LP01 modes to be less than 3.5 mm. In other words, by incorporating both the titania-doped stress regions 70a, 70b and the boron-doped stress regions 30a, 30b, a reduced boron doping concentration may be implemented. The lower level of the compressive stress in the boron-doped stress regions 30a, 30b along the slow axis can be enhanced by the tensive stress created by the titania-doped stress regions 70a, 70b along the fast axis. The reduced level of the boron doping concentration may further simplify the manufacturing process, and a variety of dopign processes, including but not limited to outside vapor deposition (OVD) process, may be implemented for manufacturing.

For example, the boron doping concentration in the stress regions 30a, 30b of the bend-insensitive polarization-maintaining fiber 200 described herein, as measured in B₂O₃ weight percent, may be less than 20 wt. %. In some embodiments, the boron doping concentration in the stress regions 30a, 30b of the bend-insensitive polarization-maintaining fiber 200 may range from about 10 wt. % to about 20 wt. %—including all sub-ranges or values therebetween. For example, in some embodiments, the boron doping concentration in the stress regions 30a, 30b of the bend-insensitive polarization-maintaining fiber 200 may range from about 10 wt. % to about 20 wt. %, from about 10 wt. % to about 18 wt. %, from about 10 wt. % to about 16 wt. %, from about 10 wt. % to about 14 wt. %, from about 10 wt. % to about 12 wt. %, from about 12 wt. % to about 20 wt. %, from about 12 wt. % to about 18 wt. %, from about 12 wt. % to about 16 wt. %, from about 12 wt. % to about 14 wt. %, from about 14 wt. % to about 20 wt. %, from about 14 wt. % to about 18 wt. %, from about 14 wt. % to about 16 wt. %, from about 16 wt. % to about 20 wt. %, from about 16 wt. % to about 18 wt. %, or from about 18 wt. % to about 20 wt. %. In some embodiments, the boron doping concentration in the stress regions 30a, 30b of the bend-insensitive polarization-maintaining fiber 200 may be greater than or equal to 10 wt. %, greater than or equal to 11 wt. %, greater than or equal to 12 wt. %, greater than or equal to 13 wt. %, greater than or equal to 14 wt. %, greater than or equal to 15 wt. %, greater than or equal to 16 wt. %, greater than or equal to 17 wt. %, greater than or equal to 18 wt. %, greater than or equal to 19 wt. %, or greater. In some embodiments, the boron doping concentration in the stress regions 30a, 30b of the bend-insensitive polarization-maintaining fiber 200 may be less than or equal to 20 wt. %, less than or equal to 19 wt. %, less than or equal to 18 wt. %, less than or equal to 17 wt. %, less than or equal to 16 wt. %, less than or equal to 15 wt. %, less than or equal to 14 wt. %, less than or equal to 13 wt. %, less than or equal to 12 wt. %, less than or equal to 11 wt. %, or less.

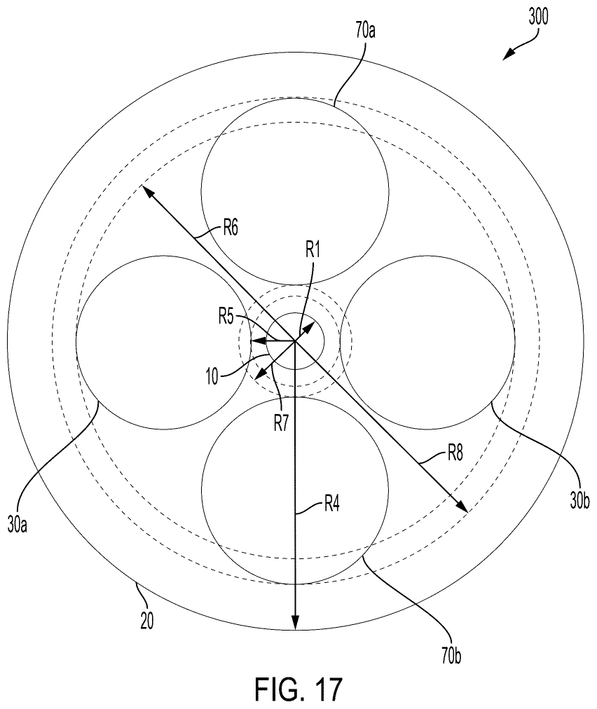

FIG. 17 schematically illustrates another exemplary polarization-maintaining fiber 300. The polarization-maintaining fiber 300 may include a core region 10 and a cladding region 20 surrounding the core region 10. The polarization-maintaining fiber 300 may be similar to the polarization-maintaining fiber 100, 200 described above in many aspects. Thus, the descriptions regarding the core region 10, the cladding region 20, the stress regions 30a, 30b, and the stress regions 70a, 70b are not repeated. Different from the polarization-maintaining fiber 100, 200, the cladding region 20 of the polarization-maintaining fiber 300 may include a uniform region. The cladding region 20 may include an inner radius corresponding to the radius R1 of the core region 10, and an outer radius corresponding to the outer radius R4 of the glass fiber. The inside radius R5 of the annular region within which the stress regions 30a, 30b may be disposed and/or the inside radius R7 of the annular region within which the stress regions 70a, 70b may be disposed may be greater than the radius R1 of the core region 10.

FIG. 18 schematically illustrates another exemplary polarization-maintaining fiber 400. The polarization-maintaining fiber 400 may be similar to the polarization-maintaining fiber 100, 200, 300 described above in many aspects. Thus, the descriptions regarding the core region 10, the cladding region 20, and the stress regions 70a, 70b are not repeated. Different from the polarization-maintaining fibers 100, 200 and similar to the polarization-maintaining fiber 300, the cladding region 20 of the polarization-maintaining fiber 400 may include a uniform region. Different from the polarization-maintaining fiber 300, the polarization-maintaining fiber 400 may not include the stress regions 30a, 30b and may only include the stress regions 70a, 70b configured to create tensile stress on the core region 10.

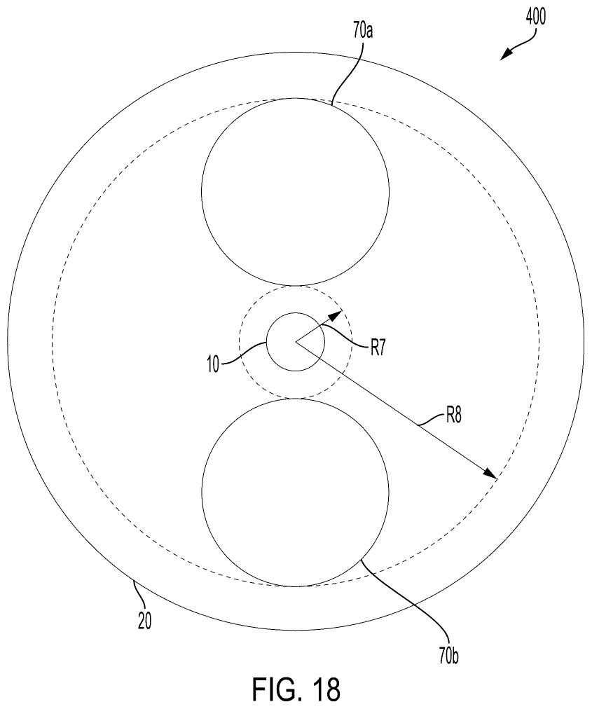

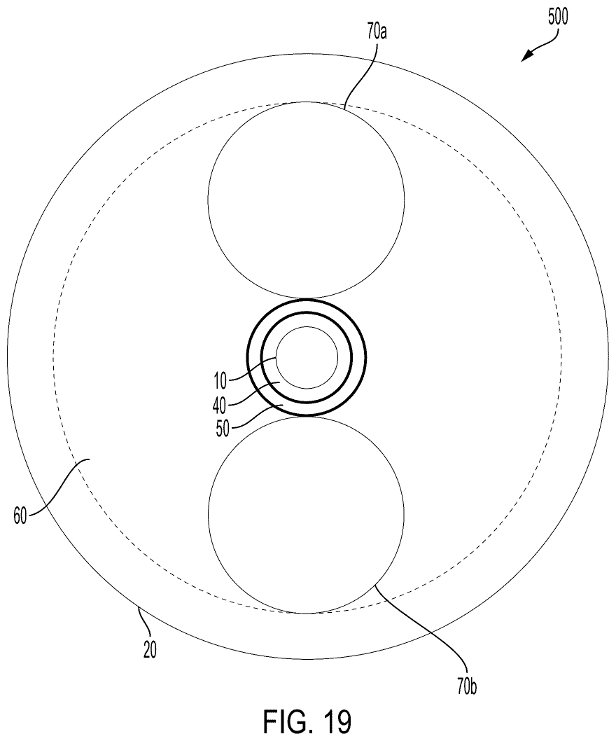

FIG. 19 schematically illustrates another exemplary polarization-maintaining fiber 500. The polarization-maintaining fiber 500 may be similar to the polarization-maintaining fiber 100, 200, 300, 400 described above in many aspects. Thus, the descriptions regarding the core region 10, the cladding region 20, the inner cladding region 40, the trench region 50, and the outer cladding region 60, and the stress regions 70a, 70b are not repeated. Different from the polarization-maintaining fiber 400, the cladding region 20 of the polarization-maintaining fiber 500 further includes the inner cladding region 40, the trench region 50, and the outer cladding region 60. In some embodiments, the inner periphery of the stress regions 70a, 70b may extend slightly radially inward into the trench region 50. In some embodiments, the inner periphery of the stress regions 70a, 70b may extend radially outward from the trench region 50. In some embodiments, a separation between the stress regions 70a, 70b may correspond to the outer radius R3 of the trench region 40.

### Manufacturing the Polarization-Maintaining Fibers

The various polarization-maintaining fibers described herein may be drawn from polarization-maintaining fiber preforms with titania-doped stress rods and/or boron-doped stress rods. In some embodiments, an intermediate fiber preform without the titania-doped stress rods and/or boron-doped stress rods may be first manufactured. The intermediate fiber preform may include various regions corresponding to the core region and the cladding which may, in some embodiments, include the inner cladding region, the trench region, and/or the outer cladding region. Holes may be drilled in the intermediate fiber preform for inserting therein the titania-doped stress rods and/or boron-doped stress rods to form the polarization-maintaining fiber preform. The titania-doped stress rods and/or boron-doped stress rods may be manufactured by various process, including but not limited to vapor deposition, such as an outside vapor deposition process. The titania-doped stress rods and/or boron-doped stress rods may each include a cylindrical rod with a substantially uniform dopant concentration. In some embodiments, one or more holes may also be drilled in the intermediate fiber preform for inserting therein one or more marker rods that correspond to the marker elements. Once the polarization-maintaining fiber preform is formed, the polarization-maintaining fiber may be drawn from the polarization-maintaining fiber preform.

### Performance Attributes

### Cutoff Wavelength

Many polarization-maintaining fiber applications utilize lengths on the order of 0.5 m or less, which places stringent requirements on the cutoff wavelength to enable single-mode operation. The various polarization-maintaining fibers described herein may exhibit short-length (e.g., less than or equal to 0.5 m) cutoff wavelengths that are well below the target operating windows of the O-band (1270-1330 nm) and/or the C-band (1530-1565 nm). The various polarization-maintaining fibers described herein may allow for single-mode operation at a deployment length of 5 m or less, 2 m or less, 1 m or less, 0.5 m or less, 0.3 m or less, at wavelengths less than 1260 nm, less than 1200 nm, or even less than 1140 nm.

In some embodiments, the 2 m cutoff of the polarization-maintaining fibers described herein may be about 1260 nm or less, or about 1250 nm or less, or about 1240 nm or less, or about 1230 nm or less, or about 1220 nm or less, or about 1210 nm or less, or about 1200 nm or less, or about 1190 nm or less, or about 1180 nm or less, or about 1170 nm or less, or about 1160 nm or less, or about 1150 nm or less, or about 1140 nm or less, or about 1130 nm or less, or about 1120 nm or less. For example, the 2 m cutoff may be from about 1120 nm to about 1260 nm, or about 1120 nm to about 1250 nm, or about 1120 nm to about 1240 nm, or about 1140 nm to about 1220 nm, or about 1160 nm to about 1200 nm, or about 1180 nm to about 1260 nm, or about 1190 nm to about 1260 nm, or about 1200 nm to about 1250 nm, or about 1200 nm to about 1240 nm, or about 1210 nm to about 1250 nm. In some embodiments, the 2 m cutoff may be about 1195 nm, or about 1198 nm, or about 1205 nm, or about 1222 nm.

In some embodiments, the 1 m cutoff of the polarization-maintaining fibers described herein may be about 1260 nm or less, or about 1250 nm or less, or about 1240 nm or less, or about 1230 nm or less, or about 1220 nm or less, or about 1210 nm or less, or about 1200 nm or less, or about 1190 nm or less, or about 1180 nm or less, or about 1170 nm or less, or about 1160 nm or less, or about 1150 nm or less, or about 1140 nm or less. For example, the 1 m cutoff may be from about 1140 nm to about 1260 nm, or about 1140 nm to about 1250 nm, or about 1140 nm to about 1240 nm, or about 1140 nm to about 1220 nm, or about 1140 nm to about 1200 nm, or about 1190 nm to about 1270 nm, or about 1200 nm to about 1260 nm, or about 1200 nm to about 1250 nm, or about 1200 nm to about 1240 nm, or about 1210 nm to about 1250 nm. In embodiments, the 1 m cutoff wavelength may be about 1195 nm, or about 1198 nm, or about 1205 nm, or about 1222 nm.

In some embodiments, the 0.5 m cutoff of the polarization-maintaining fibers described herein may be about 1260 nm or less, or about 1250 nm or less, or about 1240 nm or less, or about 1230 nm or less, or about 1220 nm or less, or about 1210 nm or less, or about 1200 nm or less, or about 1190 nm or less, or about 1180 nm or less, or about 1170 nm or less, or about 1160 nm or less, or about 1150 nm or less, or about 1140 nm or less, or about 1130 nm or less, or about 1120 nm or less. For example, the 0.5 m cutoff may be from about 1120 nm to about 1260 nm, or about 1120 nm to about 1250 nm, or about 1120 nm to about 1240 nm, or about 1140 nm to about 1220 nm, or about 1160 nm to about 1200 nm, or about 1180 nm to about 1260 nm, or about 1190 nm to about 1260 nm, or about 1200 nm to about 1250 nm, or about 1200 nm to about 1240 nm, or about 1210 nm to about 1250 nm.

The theoretical cutoff of the polarization-maintaining fibers described herein may be about 1150 nm or less, or about 1140 nm or less, or about 1130 nm or less, or about 1120 nm or less, or about 1110 nm or less, or about 1100 nm or less, or about 1090 nm or less, or about 1080 nm or less, or about 1070 nm or less. For example, the theoretical cutoff may be from about 1070 nm to about 1150 nm, or about 1070 nm to about 1130 nm, or about 1070 nm to about 1110 nm, or about 1070 nm to about 1090 nm, or from about 1090 nm to about 1150 nm, or about 1090 nm to about 1130 nm, or about 1090 nm to about 1110 nm, from about 1110 nm to about 1150 nm, or about 1110 nm to about 1130 nm, or from about 1130 nm to about 1150 nm.

### Bend Loss

As discussed above, by configuring the inside radius R5 of the annular region within which the stress regions 30a, 30b may be located to be greater than or equal to the inner radius R2 of the trench region (or stated differently, by configuring the separation between the stress regions 30a, 30b along the slow axis (i.e., 2×R5) to be greater than or equal to the inner diameter (i.e., 2×R2) of the trench region), the stress regions 30a, 30b may be located outside the inner cladding region between the core region and the trench region. Such configuration may allow low bend loss to be achieved along the fast axis of the polarization-maintaining fiber. As the bend loss along the slow axis may be generally low due to the presence of the stress regions 30a, 30b, the low bend loss along the fast axis achieved by the polarization-maintaining fiber described herein thus may enable uniformly low bend loss along both the fast and slow axes when the polarization-maintaining fiber may be bent along either the fast axis or the slow axis.

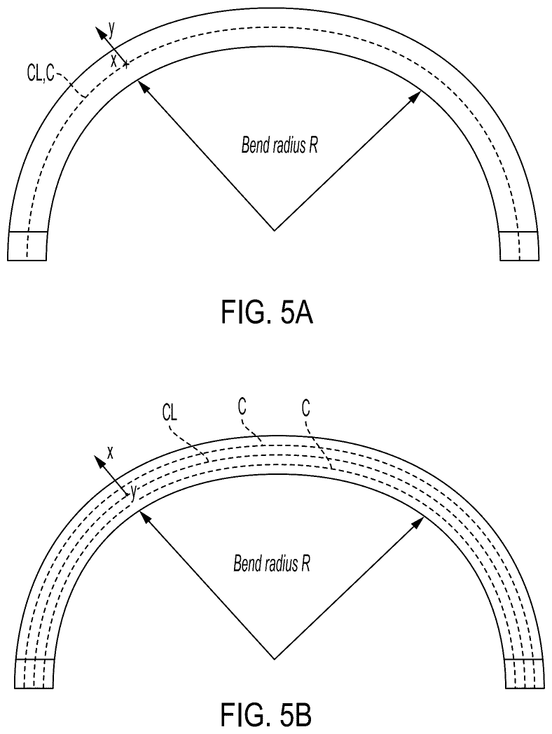

As used herein, bending along the fast axis (y axis), such as shown in FIG. 5A, refers to the scenario where the fiber is bent such that the bend radius R is perpendicular to the plane containing the slow axis (x axis) and is parallel to (or along) the fast axis (y axis). As shown in FIG. 5A, the slow axis (x axis) extends perpendicular to the paper, and the plane containing the slow axis (x axis), which is also the plane containing the centerline (CL) of the polarization-maintaining fiber and the centers (C) of the two stress regions 30a, 30b, extends perpendicular to the paper.

As also used here, bending along the slow axis (x axis), such as shown in FIG. 5B, refers to the scenario where the fiber is bent such that the bend radius R is parallel to the plane containing the slow axis (x axis) and parallel to (along) the slow axis (x axis). In FIG. 5B, the three dash lines represent the centerline (CL) of the polarization-maintaining fiber and the centers (C) of the two stress regions 30a, 30b, all in the plane containing the slow axis (x axis).

In some embodiments, the polarization-maintaining fibers described herein may have a 15 mm diameter mandrel wrap bend loss along the fast axis at 1310 nm, which can be tested by the mandrel wrap test having a diameter of 15 mm, of less than about 1.0 dB/turn, or less than about 0.75 dB/turn, or less than about 0.50 dB/turn, or less than about 0.40 dB/turn, or less than about 0.25 dB/turn, or less than about 0.20 dB/turn, or less than about 0.15 dB/turn, or less than about 0.14 dB/turn, or less than about 0.13 dB/turn, or less than about 0.12 dB/turn, or less than about 0.11 dB/turn, or less than about 0.10 dB/turn, or less than about 0.09 dB/turn, or less than about 0.08 dB/turn, or less than about 0.07 dB/turn, or less than about 0.06 dB/turn, or less than about 0.05 dB/turn.

In some embodiments, the polarization-maintaining fibers described herein may have a 10 mm diameter mandrel wrap bend loss along the fast axis at 1310 nm, which can be tested by the mandrel wrap test having a diameter of 10 mm, of less than about 2.0 dB/turn, or less than about 1.5 dB/turn, or less than about 1.0 dB/turn, or less than about 0.50 dB/turn, or less than about 0.40 dB/turn, or less than about 0.30 dB/turn, or less than about 0.28 dB/turn, or less than about 0.26 dB/turn, or less than about 0.24 dB/turn, or less than about 0.22 dB/turn, or less than about 0.20 dB/turn, or less than about 0.18 dB/turn, or less than about 0.16 dB/turn, or less than about 0.14 dB/turn, or less than about 0.12 dB/turn, or less than about 0.10 dB/turn.

In some embodiments, the polarization-maintaining fibers described herein may have a 15 mm diameter mandrel wrap bend loss along the fast axis at 1550 nm, which can be tested by the mandrel wrap test having a diameter of 15 mm, of less than about 2.0 dB/turn, or less than about 1.75 dB/turn, or less than about 1.50 dB/turn, or less than about 1.25 dB/turn, or less than about 1.0 dB/turn, or less than about 0.75 dB/turn.

### Birefriengence

While achieving low bend loss along both the slow axis and the fast axis, the polarization-maintaining fibers described herein may also demonstrate a high level of birefringence. The core region 10 of the polarization-maintaining fibers described herein may exhibit a minimum birefringence along the fast axis at about the radial position R1 of the core region 10. In some embodiments, the core region 10 of the polarization-maintaining fibers described herein may exhibit a minimum birefringence that may be greater than or equal to 2×10⁻⁴, greater than or equal to 2.5×10⁻⁴, greater than or equal to 3×10⁻⁴, greater than or equal to 3.5×10⁻⁴, greater than or equal to 4×10⁻⁴, or greater. In some embodiments, the core region 10 of the polarization-maintaining fibers described herein may exhibit a minimum birefringence ranging from about 2×10⁻⁴ to 5×10⁻⁴-including all sub-ranges or values therebetween. For example, in some embodiments, the core region 10 of the polarization-maintaining fibers described herein may exhibit a minimum birefringence ranging from about 2×10⁻⁴ to about 5×10⁻⁴, from about 2×10⁻⁴ to about 4.5×10⁻⁴, from about 2×10⁴ to about 4×10⁻⁴, from about 2×10⁻⁴ to about 3.5×10⁻⁴, from about 2×10⁻⁴ to about 3×10⁻⁴, from about 2×10⁴ to about 2.5×10⁻⁴, from about 2.5×10⁴ to about 5×10⁻⁴, from about 2.5×10⁻⁴ to about 4.5×10⁻⁴, from about 2.5×10⁻⁴ to about 4×10⁴, from about 2.5×10⁻⁴ to about 3.5×10⁻⁴, from about 2.5×10⁻⁴ to about 3×10⁴, from about 3×10⁴ to about 5×10⁻⁴, from about 3×10⁴ to about 4.5×10⁻⁴, from about 3×10⁴ to about 4×10⁴, from about 3×10⁻⁴ to about 3.5×10⁻⁴, from about 3.5×10⁻⁴ to about 5×10⁻⁴, from about 3.5×10⁻⁴ to about 4.5×10⁻⁴, from about 3.5×10⁻⁴ to about 4×10⁴, from about 4×10⁻⁴ to about 5×10⁻⁴, from about 4×10⁻⁴ to about 4.5×10⁻⁴, or from about 4.5×10⁻⁴ to about 5×10⁻⁴.

### Dispersion

The polarization-maintaining fibers described herein may have zero dispersion wavelength (λ₀) from about 1290 nm to about 1330 nm. For example, the zero dispersion wavelength may be from about 1295 nm to about 1325 nm, about 1300 nm to about 1324 nm, or from about 1305 nm to about 1315 nm. For example, the zero dispersion wavelength can be about 1280 nm, about 1285 nm, about 1289 nm, about 1290 nm, about 1300 nm, about 1301 nm, about 1305 nm, about 1306 nm, about 1310 nm, about 1315 nm, or about 1320 nm.

The polarization-maintaining fibers described herein may have a dispersion at 1310 nm in a range between about −1.5 ps/nm/km and about 1.5 ps/nm/km and a dispersion slope at 1310 nm in a range between about 0.05 ps/nm²/km and 0.1 ps/nm²/km. In some embodiments, the dispersion at 1310 nm may be from about −1.2 ps/nm/km to about 1.2 ps/nm/km, or about −1.0 ps/nm/km to about 1.0 ps/nm/km. In some embodiments, the dispersion at 1310 nm may be about −1.1 ps/nm/km, or about −0.8 ps/nm/km, or about −0.7 ps/nm/km, or about −0.4 ps/nm/km, or about −0.3 ps/nm/km, or about 0.1 ps/nm/km, or about 0.2 ps/nm/km. In some embodiments, the dispersion slope at 1310 nm may be about 0.05 ps/nm²/km to about 0.095 ps/nm²/km, or about 0.06 ps/nm²/km to about 0.1 ps/nm²/km, about 0.07 ps/nm²/km to about 0.1 ps/nm²/km, about 0.08 ps/nm²/km to about 0.1 ps/nm²/km.

### Mode Field Diameter

The polarization-maintaining fibers described herein may have a mode field diameter, at 1310 nm wavelength, of about 8.4 microns or greater, or about 8.6 microns or greater, or about 8.8 microns or greater, or about 8.9 microns or greater, or about 9.0 microns or greater, or about 9.1 microns or greater, or about 9.2 microns or greater, or about 9.3 microns or greater, or about 9.4 microns or greater, or about 9.5 microns or greater, or about 9.6 microns or greater. In some embodiments, the mode field diameter is in a range from about 8.4 microns to about 9.7 microns, or from about 8.6 microns to about 9.5 microns, or from about 8.8 microns to about 9.4 microns, or from about 9.0 microns to about 9.4 microns. For example, the mode field diameter, at 1310 nm wavelength, is about 8.88 microns, or about 8.90 microns, or about 8.91 microns, or about 9.22 microns, or about 9.34 microns.

The polarization-maintaining fibers described herein may have a mode field diameter, at 1550 nm wavelength, of about 9.2 microns to about 11.0 microns, or about 9.4 microns to about 10.8 microns, or about 9.8 microns to about 10.6 microns, or about 10.0 microns to about 10.4 microns, or about 9.8 microns to about 10.4 microns. In some embodiments, the mode field diameter, at 1550 nm wavelength, is about 9.90 microns, or about 10.09 microns, or about 10.10 microns, or about 10.24 microns, or about 10.31 microns.

### EXAMPLES

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

### Bend-Insensitive Polarization-Maintaining Fibers for C-Band (1530-1565 nm) Applications

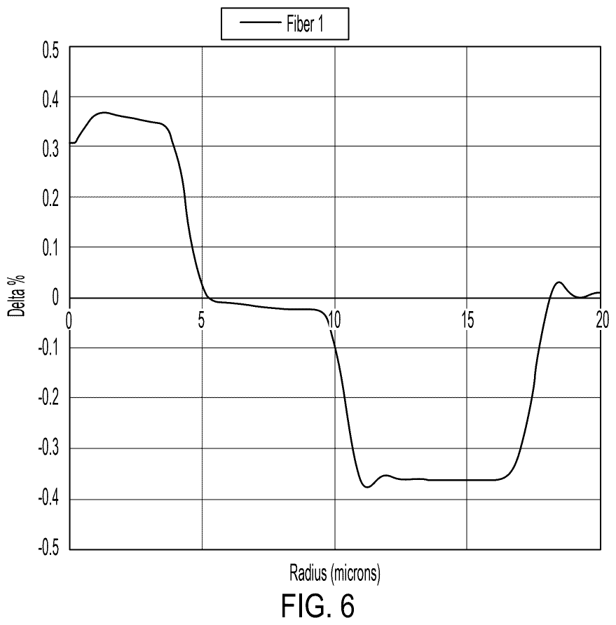

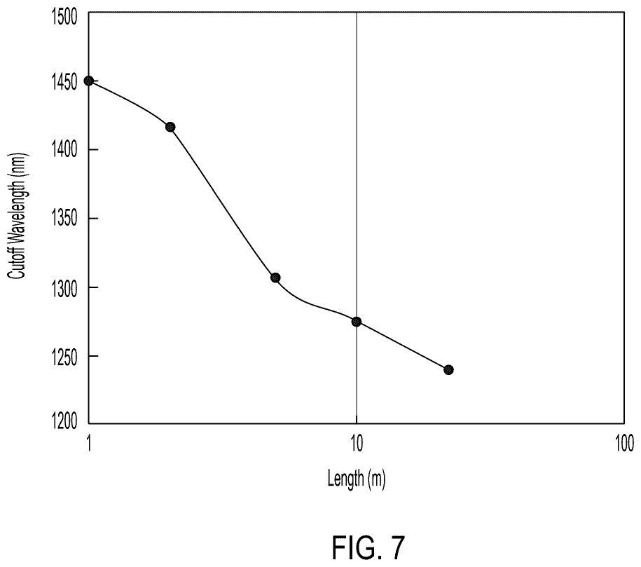

FIG. 6 shows a measured exemplary relative refractive index profile of an optical fiber that exhibits short-length cutoff wavelength below the target operating window of the C-band (1530-1565 nm). It is noted that the stress regions 30a, 30b, 70a, 70b are not shown in FIG. 6. Depending on the implementations, the stress regions 30a, 30b, 70a, 70b may start at any radial position greater than or equal to the inner radius R2 of the trench region 50. FIG. 7 is a plot of the cutoff wavelength as a function of length for the fiber of FIG. 6. As shown in FIG. 7, the cutoff wavelength is well below the lower limit of the operating window of the C-band (1530-1565 nm), which may enable single-mode operation in polarization-maintaining fiber application lengths as short as 0.5 m. Depending on the particular fiber design, the 2 m cutoff wavelength may be less than 1520 nm, more preferably less than 1500 nm, or even more preferably less than 1480 nm.

In the example shown in FIG. 6, the trench region 50 starts and ends at radial position R2 of about 10.25 μm and radial position R3 of about 17.4 μm, respectively, and the core-clad ratio (R1:R2) is about 0.44. The inner radius R2 of the trench region 50 is sufficiently small such that the stress regions, in particular stress regions 30a, 30b, may be configured to have a separation as small as about 20.5 μm without encroaching on the inner cladding region 40 between the core region 10 and the trench region 50. In some embodiments, the stress regions 30a, 30b, 70a, 70b may each have a diameter that may be greater than or equal to 35 μm and less than or equal to 40 μm. The center of each boron-doped stress region 30a, 30b may be located at a radial distance of greater than or equal to 27.5 μm and less than or equal to 32 μm from the centerline of the polarization-maintaining fiber. The center of each titania-doped stress region 70a, 70b may be located at a radial distance of greater than or equal to 31.5 μm and less than or equal to 37.5 μm from the centerline of the polarization-maintaining fiber.

Tables 1A and 1B below provide examples of drilling geometries that may be implemented for fabricating the polarization-maintaining fibers having an outer cladding diamter of about 125 μm for applications in the C-band (1530-1565 nm) (as well as applications in the O-band (1270-1330 nm) in some embodiments as discussed below). Table 1A provides examples for fabricating polarization-maintaining fibers having boron-doped stress regions 30a, 30b, and Table 1B provides examples for fabricating polarization-maintaining fibers having boron-doped stress regions 30a, 30b and titania-doped stress regions 70a, 70b. The polarization-maintaining fibers may include stress regions 30a, 30b, 70a, 70b with diameters greater than or equal to 35 μm and less than or equal to 40 μm. The polarization-maintaining fibers may be fabricated from preforms with diameters greater than or equal to 25 mm and less than or equal to 60 mm. The drilled hole sizes in the preform may be greater than or equal to 8 mm and less than or equal to 19 mm, which may be achieved with diamond and/or ultrasonic drilling methods.

TABLE 1A

| | Units | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Fiber Dimensions | | | | | | | | | |
| Fiber OD | μm | 125 | 125 | 125 | 125 | 125 | 125 | 125 | 125 |
| Boron-doped stress region center | μm | 27.5 | 27.5 | 27.5 | 27.5 | 32 | 32 | 32 | 32 |
| to fiber center | | | | | | | | | |
| Boron-doped stress region | μm | 35 | 35 | 35 | 35 | 40 | 40 | 40 | 40 |
| diameter in fiber | | | | | | | | | |
| Preform Dimensions | | | | | | | | | |
| Preform OD | mm | 28.3 | 35.3 | 42.6 | 53.2 | 27.8 | 34.1 | 43.1 | 57.8 |
| Boron-doped stress rod diameter | mm | 7.924 | 9.884 | 11.928 | 14.896 | 8.896 | 10.912 | 13.792 | 18.496 |
| in preform | | | | | | | | | |
| Target boron-doped stress rod | mm | 8 | 10 | 12 | 15 | 9 | 11 | 13.9 | 18.6 |
| hole OD | | | | | | | | | |
| Hole center to preform center | mm | 6.23 | 7.77 | 9.37 | 11.7 | 7.12 | 8.73 | 11.03 | 14.8 |

TABLE 1B

| | Units | Ex. 9 | Ex. 10 | Ex. 11 | Ex. 12 | Ex. 13 | Ex. 14 | Ex. 15 | Ex. 16 |
|---|---|---|---|---|---|---|---|---|---|
| Fiber Dimensions | | | | | | | | | |
| Fiber OD | μm | 125 | 125 | 125 | 125 | 125 | 125 | 125 | 125 |
| Boron-doped stress region center | μm | 27.5 | 27.5 | 27.5 | 27.5 | 32 | 32 | 32 | 32 |
| to fiber center | | | | | | | | | |
| Boron-doped stress region | μm | 35 | 35 | 35 | 35 | 40 | 40 | 40 | 40 |
| diameter in fiber | | | | | | | | | |
| Titania-doped stress region center | μm | 31.5 | 31.5 | 31.5 | 31.5 | 37.5 | 37.5 | 37.5 | 37.5 |
| to fiber center | | | | | | | | | |
| Titania-doped stress region | μm | 35 | 35 | 35 | 35 | 40 | 40 | 40 | 40 |
| diameter in fiber | | | | | | | | | |
| Preform Dimensions | | | | | | | | | |
| Preform OD | mm | 28.3 | 35.3 | 42.6 | 53.2 | 28.3 | 35.3 | 42.6 | 53.2 |
| Boron-doped stress rod diameter | mm | 7.92 | 9.88 | 11.93 | 14.90 | 9.06 | 11.30 | 13.63 | 17.02 |
| in preform | | | | | | | | | |
| Target boron-doped stress rod | mm | 8.00 | 10.00 | 12.00 | 15.00 | 9.20 | 11.40 | 13.70 | 17.10 |
| hole OD | | | | | | | | | |
| Boron-doped stress rod hole | mm | 6.23 | 7.77 | 9.37 | 11.70 | 7.24 | 9.04 | 10.91 | 13.62 |
| center to preform center | | | | | | | | | |
| Titania-doped stress rod diameter | mm | 7.92 | 9.88 | 11.93 | 14.90 | 9.06 | 11.30 | 13.63 | 17.02 |
| in preform | | | | | | | | | |
| Target titania-doped stress rod | mm | 8.00 | 10.00 | 12.00 | 15.00 | 9.20 | 11.40 | 13.70 | 17.10 |
| hole OD | | | | | | | | | |
| Titania-doped stress rod hole | mm | 6.92 | 8.63 | 10.41 | 13.00 | 7.73 | 9.64 | 11.63 | 14.53 |
| center to preform center | | | | | | | | | |

### Bend-Insensitive Polarization-Maintaining Fibers for O-Band (1270-1330 nm) Applications

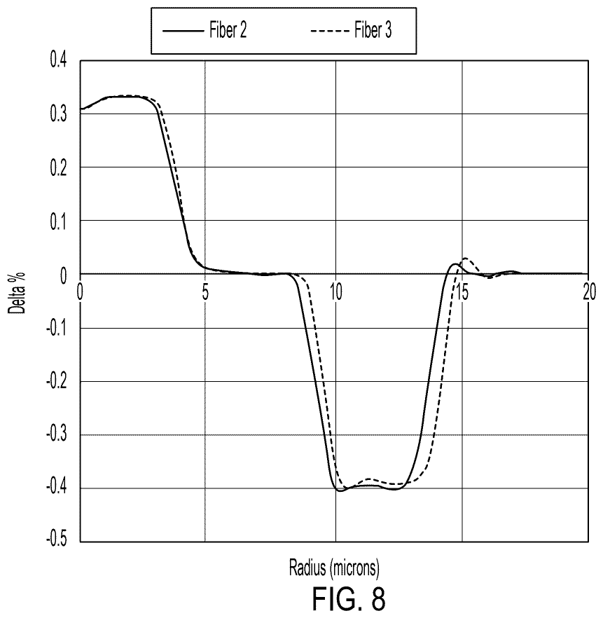

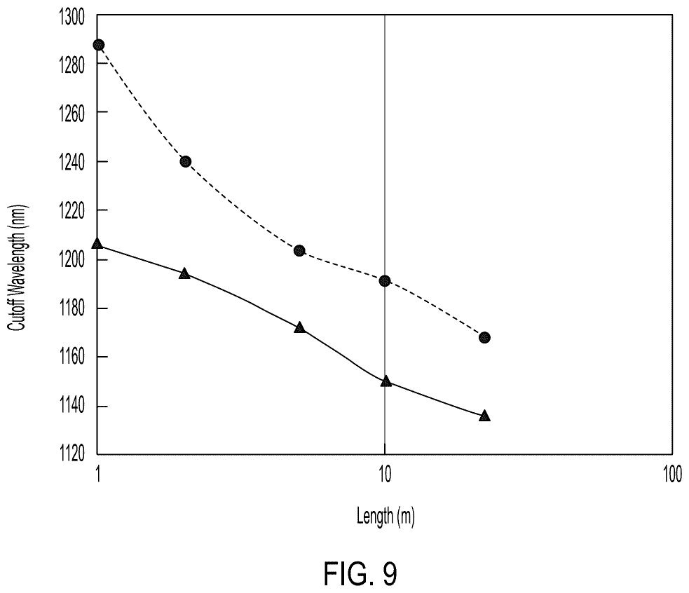

FIG. 8 shows measured exemplary relative refractive index profiles of optical fibers that exhibit short-length cutoff wavelengths below the target operating window of the O-band (1270-1330 nm). It is noted that the stress regions 30a, 30b, 70a, 70b are not shown in FIG. 8. Depending on the implementations, the stress regions 30a, 30b, 70a, 70b may start at any radial position greater than or equal to the inner radius R2 of the trench region 50. FIG. 9 is a plot of the cutoff wavelength as a function of length for the fibers of FIG. 8. As shown in FIG. 9, the cutoff wavelengths are well below the lower limit of the operating window of the O-band (1270-1330 nm), which may enable single-mode operation in polarization-maintaining fiber application lengths as short as a few tens of centimeters.

In the non-limiting examples shown, the bend-insensitive polarization-maintaining fibers for operating in the O-band (1270-1330 nm) may have a trench region 50 with an inner radius R2 of greater than or equal to 9 μm and less than or equal to 10 μm. The boron-doped stress regions 30a, 30b in the polarization-maintaining fiber may be configured to have a separation as small as about 18 μm (e.g., >18 μm) so that they may not encroach into the inner cladding region 40 between the core region 10 and the trench region 50. In some embodiments, the stress regions 30a, 30b, 70a, 70b may each have a diameter that may be greater than or equal to 35 μm and less than or equal to 40 μm. The center of each boron-doped stress region 30a, 30b may be located at a radial distance of greater than or equal to 27.5 μm and less than or equal to 32 μm from the centerline of the bend-insensitive polarization-maintaining fiber. The center of each titania-doped stress region 70a, 70b may be located at a radial distance of greater than or equal to 26 μm and less than or equal to 38 μm from the centerline of the polarization-maintaining fiber.

Table 2 summarizes further exemplary profile parameters and modeled attributes for the bend-insensitive polarization-maintaining fibers for operating in the O-band (1270-1330 nm), with the inner radius R2 of the trench region 50 being greater than or equal to 9 μm and less than or equal to 10 μm. Additional exemplary profiles that may be suitable for the bend-insensitive polarization-maintaining fibers are described in U.S. patent application Ser. No. 18/411,175, the content of which is incorporated by reference in its entirety.

TABLE 2

| | Fiber 4 | Fiber 5 | Fiber 6 | Fiber 7 | Fiber 8 | Fiber 9 | Fiber 10 | Fiber 11 | Fiber 12 | Fiber 13 |
|---|---|---|---|---|---|---|---|---|---|---|
| Delta1 (%) | 0.323 | 0.327 | 0.317 | 0.343 | 0.308 | 0.345 | 0.352 | 0.330 | 0.340 | 0.337 |
| R1 (μm) | 4.22 | 4.33 | 4.38 | 4.12 | 4.46 | 4.25 | 4.44 | 4.48 | 4.17 | 4.36 |
| Alpha | 7.41 | 6.95 | 7.15 | 6.90 | 8.11 | 9.86 | 5.26 | 7.63 | 8.38 | 7.66 |
| V1 (%-microns²) | 4.53 | 4.76 | 4.75 | 4.51 | 4.91 | 5.19 | 5.04 | 5.25 | 4.77 | 5.08 |
| Delta2 (%) | 0.000 | 0.000 | 0.000 | 0.000 | 0.000 | 0.000 | 0.000 | 0.000 | 0.000 | 0.000 |
| R2 (μm) | 9.52 | 9.73 | 9.52 | 9.52 | 9.58 | 9.00 | 9.81 | 9.13 | 9.96 | 9.80 |
| R1/R2 | 0.44 | 0.44 | 0.46 | 0.43 | 0.47 | 0.47 | 0.45 | 0.49 | 0.42 | 0.45 |
| Delta3 (%) | −0.433 | −0.419 | −0.420 | −0.399 | −0.431 | −0.379 | −0.449 | −0.429 | −0.396 | −0.382 |
| R3 (μm) | 14.30 | 13.23 | 14.04 | 13.71 | 14.23 | 14.06 | 13.23 | 12.88 | 14.23 | 13.43 |
| V3 (%-microns²) | −49.33 | −33.59 | −44.70 | −38.84 | −47.67 | −44.31 | −35.30 | −35.40 | −40.86 | −32.26 |
| 1310 MFD (μm) | 9.04 | 9.08 | 9.16 | 8.84 | 9.29 | 8.80 | 8.84 | 9.02 | 8.85 | 8.96 |
| 1550 MFD (μm) | 10.21 | 10.25 | 10.30 | 10.02 | 10.42 | 9.89 | 10.03 | 10.11 | 10.08 | 10.14 |
| 1310 Dispersion (ps/nm/km) | −0.14 | −0.07 | 0.27 | −0.63 | 0.60 | 0.19 | −0.62 | 0.55 | −0.90 | −0.31 |
| 1310 Slope (ps/nm²/km) | 0.092 | 0.091 | 0.092 | 0.091 | 0.092 | 0.091 | 0.091 | 0.092 | 0.090 | 0.090 |
| Zero Dispersion (nm) | 1311.6 | 1310.7 | 1307.0 | 1316.9 | 1303.5 | 1307.9 | 1316.8 | 1304.0 | 1320.0 | 1313.4 |
| Theoretical Cutoff (nm) | 1094 | 1121 | 1116 | 1096 | 1130 | 1138 | 1123 | 1139 | 1103 | 1132 |
| 2 m Cutoff (nm) | 1214 | 1222 | 1236 | 1216 | 1250 | 1258 | 1243 | 1259 | 1224 | 1252 |
| 15 mm Diameter Bend Loss | 0.06 | 0.04 | 0.01 | 0.07 | 0.07 | 0.01 | 0.04 | 0.02 | 0.04 | 0.02 |
| at 1310 nm (dB/turn)* | | | | | | | | | | |
| 15 mm Diameter Bend Loss | 1.33 | 1.27 | 1.26 | 1.22 | 1.22 | 0.69 | 0.93 | 0.96 | 1.11 | 1.01 |
| at 1550 nm (dB/turn)* | | | | | | | | | | |

*The bend is along the fast axis of the exemplary bend-insensitive polarization-maintaining fibers.

The same or similar exemplary drilling geometries given in Table 1 above may be utilized for fabricating polarization-maintaining fibers having an outer cladding diamter of about 125 μm for applications in the O-band (1270-1330 nm). The polarization-maintaining fibers may include stress regions 30a, 30b, 70a, 70b with diameters greater than or equal to 35 μm and less than or equal to 40 μm. The polarization-maintaining fibers may be fabricated from preforms with diameters greater than or equal to 25 mm and less than or equal to 60 mm. The drilled hole sizes in the preform may be greater than or equal to 8 mm and less than or equal to 19 mm, which may be achieved with diamond and/or ultrasonic drilling methods.

### Finite Element Modeling (FEM) for Birefringence

Finite element modeling (FEM) for birefringence of the fiber core was performed in accordance with the approach described in the article “Stress birefrigence analsys of polarization-maintaining fibers,” by Guan et al. in Optical Fiber Technology vol. 10, pp. 240-254 (2005). The stress-strain is given by the following:

$$T = [ K ] ( S - {S}_{0} ) \qquad ( 10 )$$

$$with$$

$$[ K ] = [ \begin{matrix}\frac{( 1 - v ) E}{( 1 + v ) ( 1 - 2 v )} & \frac{vE}{( 1 + v ) ( 1 - 2 v )} & 0 \\ \frac{vE}{( 1 + v ) ( 1 - 2 v )} & \frac{( 1 - v ) E}{( 1 + v ) ( 1 - 2 v )} & 0 \\ 0 & 0 & \frac{E}{2 ( 1 + v )}\end{matrix} ] \qquad ( 11 )$$

$$T = [ \begin{matrix}{σ}_{x} \\ {σ}_{y} \\ {σ}_{xy}\end{matrix} ] \qquad ( 12 )$$

$$S = [ \begin{matrix}{S}_{xx} \\ {S}_{yy} \\ 2 {S}_{xy}\end{matrix} ] \qquad ( 13 )$$

$${S}_{0} = [ \begin{matrix}( 1 + v ) αΔ T \\ ( 1 + v ) αΔ T \\ 0\end{matrix} ] \qquad ( 14 )$$

where E is Young's modulus, v is Poisson's ratio, a is the thermal expansion coeffcient, ΔT is the temperature change from 1100° C. to 23° C. (negative on cooling), σₓ, σ_{y} are called the normal stress, S₀ is called the initial strain, Sₓₓ, S_{yy} are the normal strains, and S_{xy} and σ_{xy} are the shear strain and stress, respectively.

The birefringence of the fiber core is given by Bₛ=c(σₓ−σ_{y}), where σₓ and σ_{y} are the stress along the slow axis (or the x direction) and the fast axis (or the y direction), respectively, and c=3.43e−6 MPa⁻¹.

The parameters used in the FEM analysis are given in Table 3 below.

TABLE 3

| | Elastic | | |
|---|---|---|---|
| | Modulus | Poisson's | CTE |
| | (MPa) | Ratio | (1e−6/° C.) |
| Silica | 72700 | 0.165 | 0.43 |
| Germanium-doped core | — | — | 0.89 |
| Fluorine-doped trench region | — | — | 0.28 |
| Boron-doped stress region | — | — | 1.826 |
| (15 wt %) | | | |
| Boron-doped stress region | — | — | 2.7 |
| (22 wt %) | | | |
| Titania-doped stress region | 70799 | 0.168 | 0.13 |
| (5 wt %) | | | |
| Titania-doped stress region | 67991 | 0.174 | −0.16 |
| (9 wt %) | | | |

Table 4 summarizes exemplary fiber geometries for the FEM analysis and the minimum and maximum birefringence values calculated using FEM. The exemplary fibers 14-17 each include a germanium-doped core with 6.7 wt. % germania, a fluorine-doped trench region 50 with 1.3 wt. % fluorine, and boron-doped stress regions 30a, 30b with varying amounts of boron. Exemplary fibers 14-16 are configured for bend-insensitive polarization-maintaining fiber applications in the C-band (1530-1565 nm), and exemplary fiber 17 is configured for bend-insensitive polarization-maintaining fiber applications in the O-band (1270-1330 nm).

TABLE 4

| | Fiber 14 | Fiber 15 | Fiber 16 | Fiber 17 |
|---|---|---|---|---|
| Core radius R1 (μm) | 4.5 | 4.5 | 4.5 | 4.5 |
| Inner radius R2 of | 10.4 | 10.4 | 10.4 | 9.5 |
| trench region (μm) | | | | |
| Outer radius R3 of | 17.4 | 17.4 | 17.4 | 14 |
| trench region (μm) | | | | |
| B₂O₃ (wt %) | 22 | 15 | 15 | 15 |
| Separation of boron- | 24 | 24 | 21 | 21 |
| doped stress regions (μm) | | | | |
| Diameter of boron- | 38 | 38 | 38 | 38 |
| doped stress regions (μm) | | | | |
| Minimum cladding | 12.5 | 12.5 | 14 | 14 |
| thickness Tc_{MIN}(C) along | | | | |
| the slow axis(μm) | | | | |
| Modeled Min Bs | 4.11E−04 | 2.51E−04 | 2.90E−04 | 2.84E−04 |
| Modeled Max Bs | 4.77E−04 | 2.93E−04 | 3.41E−04 | 3.35E−04 |

As shown, all of the exemplary fibers 14-17 demonstrate satisfactory birefringence characteristics for bend-insensitive polarization-maintaining fiber applications. When boron doping concentration is decreased from 22 wt. % in exemplary fiber 14 to 15 wt. % in exemplary fiber 15, a 39% decrease in the birefringence is observed. The reduced boron doping concentration may provide greater ease and flexibility in manufacturing, such as improved compatibility with an outside vapor deposition (OVD) process. Exemplary fibers 16 and 17 demonstrate that decreasing the separation of the boron-doped stress regions 30a, 30b from 24 μm to 21 μm so that the boron-doped stress regions 30a, 30b are disposed closer to, e.g., touching or aligned with in some instances, the inner radius R2 of the fluorine-doped trench region 50 restores about 20% of the birefringence that is lost when the boron level in the boron-doped stress regions 30a, 30b is decreased from 22 wt. % to 15 wt. %.

Table 5 summarizes additional exemplary fiber geometries for the FEM analysis and the minimum and maximum birefringence values calculated using FEM. The exemplary fibers 18-21 each include a germanium-doped core with 6.7 wt. % germania, a fluorine-doped trench region 50 with 1.3 wt. % fluorine, boron-doped stress regions 30a, 30b with 15 wt. % B₂O₃, and titania-doped stress regions 70a, 70b with varying amounts of TiO₂.

TABLE 5

| | Fiber 18 | Fiber 19 | Fiber 20 | Fiber 21 |
|---|---|---|---|---|
| Core radius R1 (μm) | 4.5 | 4.5 | 4.5 | 4.5 |
| Inner radius R2 of | 10.4 | 10.4 | 9.5 | 9.5 |
| trench region (μm) | | | | |
| Outer radius R3 of | 17.4 | 17.4 | 14 | 14 |
| trench region (μm) | | | | |
| B₂O₃ (wt. %) | 15 | 15 | 15 | 15 |
| Separation of boron- | 21 | 21 | 21 | 21 |
| doped stress regions (μm) | | | | |
| Diameter of boron- | 38 | 38 | 38 | 38 |
| doped stress regions (μm) | | | | |
| Minimum cladding | 14 | 14 | 14 | 14 |
| thickness Tc_{MIN}(C) along | | | | |
| the slow axis (μm) | | | | |
| TiO₂ (wt. %) | 5 | 9 | 5 | 9 |
| Separation of titania- | 35 | 35 | 30 | 30 |
| doped stress regions (μm) | | | | |
| Diameter of titania- | 38 | 38 | 38 | 38 |
| doped stress regions (μm) | | | | |
| Minimum cladding | 7 | 7 | 9.5 | 9.5 |
| thickness Tc_{MIN}(T) along | | | | |
| the fast axis (μm) | | | | |
| Modeled Min Bs | 3.33E−04 | 3.67E−04 | 3.41E−04 | 3.85E−04 |
| Modeled Max Bs | 3.80E−04 | 4.10E−04 | 3.86E−04 | 4.24E−04 |

All of the exemplary fibers 18-21 illustrate that the titania-doped stress regions 70a, 70b placed along the fast axis (perpendicular to the slow axis with the boron-doped stress regions 30a, 30b) adds tensile stress that can increase the birefringence compared to the exemplary fibers 16 and 17 with no titania-doped stress regions 70a, 70b. In the exemplary fibers 18-21, the titania-doped stress regions 70a, 70b are disposed outside the F-doped trench region 50 to minimize the risk of the titania-doped stress regions 70a, 70b acting as waveguides due to their positive relative refractive indices.

Example fibers 18 and 19 illustrate that the addition of titania-doped stress regions 70a, 70b with 5 wt. % TiO₂ and 9 wt. % TiO₂, respectively, result in improved birefringence characteristics with respect to exemplary fiber 16 having no titania-doped stress regions 70a, 70b. Exemplary fiber 19 further illustrates that the addition of titania-doped stress regions 70a, 70b with 9 wt. % TiO₂ results in further improved birefringence characteristics with respect to exemplary fiber 18 having titania-doped stress regions 70a, 70b with 5 wt. % TiO₂. Exemplary fiber 20 illustrates that the addition of titania-doped stress regions 70a, 70b with 5 wt. % TiO₂ results in improved birefringence characteristics with respect to exemplary fiber 17 having no titania-doped stress regions 70a, 70b. Exemplary fiber 21 illustrates that the addition of titania-doped stress regions 70a, 70b with 9 wt. % TiO₂ results in further improved birefringence characteristics.

Table 6 summarizes additional exemplary fiber geometries for the FEM analysis and the minimum and maximum birefringence values calculated using FEM. The exemplary fibers 22-24 each include a germanium-doped core with 6.7 wt. % germania, a fluorine-doped trench region 50 with 1.3 wt. % fluorine, boron-doped stress regions 30a, 30b with 15 wt. % B₂O₃, and titania-doped stress regions 70a, 70b with varying amounts of TiO₂, i.e., 0 wt. %, 5 wt. %, and 9 wt. %, where 0 wt. % indicates that the fiber does not include titania-doped stress regions 70a, 70b.

TABLE 6

| | Fiber 22 | Fiber 23 | Fiber 24 |
|---|---|---|---|
| Core radius R1 (μm) | 4.5 | 4.5 | 4.5 |
| Inner radius R2 of | 8.5 | 8.5 | 8.5 |
| trench region (μm) | | | |
| Outer radius R3 of | 15 | 15 | 15 |
| trench region (μm) | | | |
| B₂O₃ (wt. %) | 15 | 15 | 15 |
| Separation of boron- | 17 | 17 | 17 |
| doped stress regions (μm) | | | |
| Diameter of boron- | 34 | 34 | 34 |
| doped stress regions (μm) | | | |
| TiO₂ (wt. %) | 0 | 5 | 9 |
| Separation of titania- | — | 30 | 30 |
| doped stress regions (μm) | | | |
| Diameter of titania- | — | 34 | 34 |
| doped stress regions (μm) | | | |
| Modeled Min Bs | 3.290E−04 | 3.849E−04 | 4.274E−04 |
| Modeled Max Bs | 4.001E−04 | 4.491E−04 | 4.866E−04 |

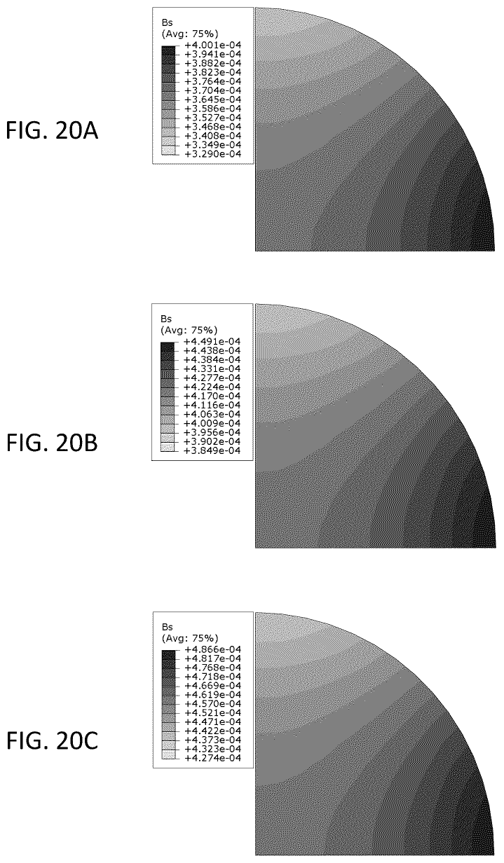

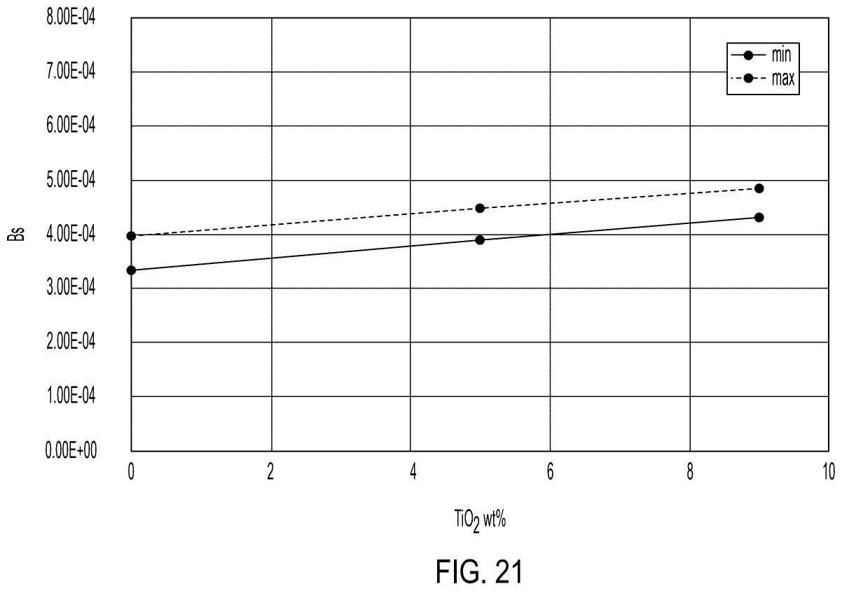

FIGS. 20A, 20B, and 20C are simulated birefringence characteristics of a quadrant (sectioned by the slow axis and the fast axis) of each of the core regions 10 of exemplary fibers 22, 23, and 24, respectively. FIG. 21 is a plot of modeled birefringence based on the birefringence of exemplary fibers 22-24. The exemplary fibers 22-24 further demonstrate that the titania-doped stress regions 70a, 70b can improve the polarization-maintaining performance.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A polarization-maintaining fiber, comprising:
a core region having a radius R1;
a cladding region having an outer radius R4 and comprising a depressed index trench region having an inner radius R2 and an outer radius R3; and
a stress region located in an annular region having an inside radius R5 and an outside radius R6;
wherein:
a center of the stress region is offset from a centerline of the core region; and
the inner radius R2 of the trench region is less than or equal to the inside radius R5 of the annular region.

2. The polarization-maintaining fiber of claim 1, wherein the stress region is a first stress region, the polarization-maintaining fiber further comprising a second stress region located in the annular region.

3. The polarization-maintaining fiber of claim 1, wherein a ratio of the radius R1 of the core region to the inner radius R2 of the depressed index trench region is greater than or equal to 0.4 and/or less than or equal to 0.5.

4. The polarization-maintaining fiber of claim 1, wherein:
the inside radius R5 of the annular region is greater than or equal to 6 μm and/or less than or equal to 16 μm; and/or
the outside radius R6 of the annular region is greater than or equal to 30 μm and/or less than or equal to 55 μm.

5. The polarization-maintaining fiber of claim 1, wherein:
the outer radius R3 of the trench region is greater than or equal to the inside radius R5 of the annular region; and/or
the outer radius R3 of the trench region is less than or equal to the outside radius R6 of the annular region.

6. The polarization-maintaining fiber of claim 1, wherein the stress region is configured to create compressive stress on the core region.

7. The polarization-maintaining fiber of claim 1, wherein the stress region comprises a boron-doped stress region.

8. The polarization-maintaining fiber of claim 7, wherein the boron-doped stress region comprises greater than or equal to 14 wt. % B₂O₃ and/or less than or equal to 24 wt. % B₂O₃.

9. The polarization-maintaining fiber of claim 1, wherein the core region comprises a minimum birefringence greater than or equal to 2×10⁻⁴ and/or less than or equal to 5×10⁻⁴.

10. The polarization-maintaining fiber of claim 1, wherein:
the inner radius R2 of the depressed index trench region is greater than or equal to 6 μm and/or less than or equal to 14 μm; and/or
the outer radius R3 of the depressed index trench region is greater than or equal to 8 μm and/or less than or equal to 20 μm;
the depressed index trench region comprises a trench volume V3 greater than or equal to −80%-micron² and/or less than or equal to −20%-micron².

11. The polarization-maintaining fiber of claim 1, wherein a minimum distance between a periphery of the cladding region and a periphery of the stress region is greater than or equal to 10 μm and/or less than or equal to 20 μm.

12. The polarization-maintaining fiber of claim 1, wherein:
a 2 m cutoff wavelength of the polarization-maintaining fiber is less than or equal to 1260 μm; and/or
a 1 m cutoff wavelength of the polarization-maintaining fiber is less than or equal to 1260 μm; and/or
a 0.5 m cutoff wavelength of the polarization-maintaining fiber is less than or equal to 1260 μm.

13. The polarization-maintaining fiber of claim 1, wherein:
the core region comprises a core volume V1 greater than or equal to 4%-micron² and/or less than or equal to 6%-micron²; and/or
the radius R1 of the core region is greater than or equal to 3 μm and/or less than or equal to 7 μm; and/or
a maximum relative refractive index Δ₁ₘₐₓ of the core region is greater than or equal to 0.15% and/or less than or equal to 0.5%.

14. The polarization-maintaining fiber of claim 1, wherein the outer radius R4 of the cladding region is greater than or equal to 40 μm and/or less than or equal to 65 μm.

15. A preform for making any of the polarization-maintaining fiber of claim 1.

16. A polarization-maintaining fiber, comprising:
a core region having a radius R1;
a cladding region surrounding the core region and having an outer radius R4; and
a first stress region that is located in a first annular region having an inside radius R5 and an outside radius R6; and
a second stress region that is located in a second annular region having an inside radius R7 and an outside radius R8; wherein:
the first stress region is configured to create compressive stress on the core region; and
the second stress region is configured to create tensile stress on the core region.

17. The polarization-maintaining fiber of claim 16, wherein:
the first stress region comprises a boron-doped stress region; and/or
the second stress region comprises a titania-doped stress region.

18. A polarization-maintaining fiber, comprising:
a core region having a radius R1;
a cladding region surrounding the core region and having an outer radius R4; and
a stress region located in an annular region having an inside radius R7 and an outside radius R8, wherein:
a center of the stress region is offset from a center line of the core region;
the stress region comprises a titania-doped stress region;
the inner radius R7 of the annular region is greater than or equal to the radius R1 of the core region; and
the outer radius R8 of the annular region is less than or equal to the radius R4 of the cladding region.

19. The polarization-maintaining fiber of claim 18, wherein the stress region comprises greater than or equal to 5 wt. % TiO₂ and/or less than or equal to 12 wt. % TiO₂.

20. The polarization-maintaining fiber of claim 18, further comprising:
a depressed index trench region having an inner radius R2 and an outer radius R3.
